(19) United States
(12) Patent Application Publication
(10) Pub. No.: US 2021/0385522 A1
(43) Pub. Date: Dec. 9, 2021

(54) METHODS AND SYSTEMS FOR CONTENT DELIVERY SESSION RECOVERY

(71) Applicant: COMCAST CABLE COMMUNICATIONS, LLC, Philadelphia, PA (US)

(72) Inventor: Alexander Giladi, Denver, CO (US)

(21) Appl. No.: 17/340,883

(22) Filed: Jun. 7, 2021

Related U.S. Application Data
(63) Continuation of application No. 63/035,609, filed on Jun. 5, 2020.

(51) Int. Cl. H04N 21/437

(52) U.S. Cl. CPC H04N 21/437

(57) ABSTRACT

A first computing device may receive an indication of a second computing device. The first computing device may determine a continuity element based on a continuity between a representation of a content item located at the first computing device and a representation of the content item located at the second computing device. The first computing device may generate a data file associated with the content item. The data file may include a reference to the second computing device and the continuity element. The first computing device may receive a request for the content item from a user device. The first computing device may send the data file to the first computing device.

### CROSS-REFERENCE TO RELATED PATENT APPLICATION

This application claims the benefit of and priority to U.S. Provisional Patent Application No. 63/035,609, filed Jun. 5, 2020, the entire contents of which are hereby incorporated herein by reference in its entirety.

### BACKGROUND

Uninterrupted delivery of content improves the overall user experience when streaming media content. For example, a user streaming content to a media player may consume the content without pauses and/or loss (e.g., no video, a display of a blank/black screen, etc.). In the case of high-value wide-distribution channels and events, there is a need for a very high degree of reliability in content delivery. Sources of failure include links between computing devices (e.g., encoders, packagers, origin servers, HTTP servers, etc.) and a user device (e.g., a content/media player, a client device, a smart device, a mobile device, etc.), a loss of a mezzanine feed, and/or a loss of another network device such as a transcoder, etc. Some sources of failure may have catastrophic consequences that affect all viewers of a channel.

A common technique for mitigating such failures is through geographically distributed transcoders and/or computing devices (e.g., encoders, packagers, origin servers, HTTP servers, etc.). In some instances, a transcoder and a computing device may be separate devices. In some instances, a transcoder and a computing device may be configured together as a single device. To make content delivery resilient to the loss of a network device/component, such as a transcoder, computing device, and/or a complete data center, a mezzanine source may be sent to a location in Colorado and to a different location in the New York. For example, two geographically distributed transcoders may output segments into two different computing devices (e.g., encoders, packagers, origin servers, HTTP servers, etc.), which may or may not be co-located. If the computing devices are synchronized, the user device may pick a computing device at will and switch between the computing devices in case of a failure. However, there is no guarantee that the segments and the MPDs are identical across these two computing devices. Still, the user device needs to be switched between computing devices (e.g., an origin A to an origin B, etc.) with minimal downtime in the event of a session/service interruption with a computing device when computing devices are unsynchronized. A typical solution for unsynchronized computing devices and/or origins is a full retune/reconfiguration of a content delivery session where the user device stops, reloads a new MPD, buffers content, requests a new digital rights media (DRM) license, and/or the like. A full retune/reconfiguration of a content delivery session results in the user device experiencing at least 15-20 seconds without any content (e.g., no video, a display of a blank/black screen, etc.).

### SUMMARY

It is to be understood that both the following general description and the following detailed description are exemplary and explanatory only and are not restrictive. Methods and systems for content delivery session recovery are described.

A content item (e.g., streaming video/audio, video-on-demand (VOD), multimedia, etc.) may correspond to multiple representations, each representation varying across bit rate, format, or other parameters. Each representation of the content item may comprise a plurality of portions/segments and may be associated with a different source/origin of the content item. A user device (e.g., a content/media player, a client device, a smart device, a mobile device, etc.) requesting the content item may receive one or more portions/segments of different representation of the content item from a different source/origin of the content item.

A data file (e.g., a media presentation description (MPD) file, a manifest file, etc.) may be used for content delivery and/or redelivery in case of an interruption. The user device may use the data file to request one or more portions of the content item. The data file may describe each representation of the content item and include references to each portion/segment of each representation of the content item. The references may include, for example, Uniform Resource Locators (URLs) and/or the like. The data file may be encoded as a tree of elements (e.g., one or more parent or high-level elements, each of which may include one or more child or lower-level elements), for example, using Extensible Markup Language (XML) or another format. The data file may include an element, such as a continuity element, that enables the user device to receive the content item (e.g., representations of the content item, etc.) from an alternate and/or substitute source/origin in the event that an original source/origin of the content item fails and/or is otherwise unavailable.

The continuity element enables switching between sources/origins, for example in a scenario where content delivery is interrupted, to be performed with a reduced and/or minimal amount of downtime. The continuity element may indicate continuity between representations of the content item. Continuity between representations of the content item may be associated with a perceptual continuity/similarity between representations of the content item. For example, continuity between representations of the content item may imply that portions/segments of different representations of the content item with matching timing information (e.g., wall clock, etc.) are perceptually identical. Continuity between representations of the content item may imply that one or more identifiers, indicators, and/or the like associated with the content item match (e.g., are identical) among components of the content item, such as adaptation sets, representations, and sub-representation. Continuity between representations of the content item may imply that security elements/information, such as licenses (e.g., a digital rights management (DRM) license, key identifiers, etc.), authorizations, and/or the like, between representations of the content are valid and/or shared.

If an interruption occurs delivery of the content, for example, while the user device is requesting/receiving a representation of the content, the continuity element in the data file may be used to control how the user device responds to the interruption. For example, if an interruption to content delivery is caused by a failure of the source/origin of the representation, the continuity element may instruct the user device to maintain any portion/segment of a representation of the content item that has already been received (e.g., stored in a buffer of the user device, etc.) and request additional portions/segments of another representation of the content item from a different source/origin, which may minimize the duration of the interruption to content delivery. The continuity element may instruct the user device to continue receiving representations of the content item (e.g., continue a session, etc.) using a current security element (e.g., a DRM license, encryption key, etc.) instead of requesting a new security element before receiving representations of the content item from a different source/origin, which may minimize the duration of the interruption to content delivery.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein: FIG. 1 shows a system for content delivery session recovery;

FIG. 2 shows semantics for a continuity element used for content delivery session recovery;

FIG. 3A shows an example system for content delivery session recovery;

FIG. 3B shows an example system for content delivery session recovery;

FIG. 3C shows an example system for content delivery session recovery;

FIG. 4 shows an example content delivery session;

FIG. 5 shows an example content delivery session;

FIG. 6 shows a block diagram of a computing device for implementing content delivery session recovery;

FIG. 7 shows a flowchart of a method for content delivery session recovery;

FIG. 8 shows a flowchart of a method for content delivery session recovery;

FIG. 9 shows a flowchart of a method for content delivery session recovery;

FIG. 10 shows a flowchart of a method for content delivery session recovery; and

FIG. 11 shows a flowchart of a method for content delivery session recovery.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as businesses or groups). Content may be electronic representations of video, audio, text, and/or graphics, which may be but is not limited to electronic representations of videos, movies, or other multimedia, which may be but is not limited to data files adhering to MPEG-2, MPEG-4, Matroska format or some other video file format whether such format is presently known or developed in the future. The content items described herein may be electronic representations of music, spoken words, or other audio, which may be but is not limited to data files adhering to the MPEG-1 Audio Layer 3 (.MP3) format, AAC, MPEG-H, AC-3, E-AC-3, AC-4, Atmos, MPEG-2, MPEG-4 AVC (ITU-T Rec H.264), MPEG HEVC, MPEG VVC, MPEG EVC, MPEG LC-EVC, VP9, AOM AV1, JPEG-XS, Apple ProRes format or some other format configured to store electronic audio whether such format is presently known or developed in the future. In some cases, content may be data files adhering to the following formats: JPEG (.JPG) format, Portable Network Graphics (.PNG) format, HEIF, JPEG2000 format or some other format for electronically storing text, graphics and/or other information whether such format is presently known or developed in the future. Content items may be any combination of the above-described formats.

“Consuming content” or the “consumption of content,” as those phrases are used herein, may also be referred to as “accessing” content, “providing” content, “viewing” content, “listening” to content, “rendering” content, or “playing” content, among other things. In some cases, the particular term utilized may be dependent on the context in which it is used. Consuming video may also be referred to as viewing or playing the video. Consuming audio may also be referred to as listening to or playing the audio.

This detailed description may refer to a given entity performing some action. It should be understood that this language may in some cases mean that a system (e.g., a computer) owned and/or controlled by the given entity is actually performing the action.

A user device (e.g., a content/media player, a client device, a smart device, a mobile device, etc.) engaged in a content delivery session may switch from one redundant computing device (e.g., encoder, packager, origin server, HTTP server, etc.) to another with a minimal amount of downtime. For example, a user device may be a DASH client presenting content (e.g., streaming video/audio, video-on-demand (VOD), multimedia, etc.) from a data file (e.g., a media presentation description (MPD) file, a manifest file, etc.), such as a dynamic MPD, may periodically request a new MPD (“MPD update”). Rules defined in section 5.4 of the ISO/IEC 23009-1 5^{th} ed. specification, which define what can and what cannot be changed between two consecutive MPDs. One of the key invariants is the past—all information conveyed by the previous MPD must be valid in the new MPD. When redundant computing devices (e.g., encoder, packager, origin server, HTTP server, etc.), such as an origin A and an origin B, are not perfectly synchronized, even though they may manage/distribute the same content (e.g., representations of the same content, etc.), the content item managed by each computing device may have different characteristics. For example, content items managed/distributed by origin A and origin B may include different timestamps, different period start times, different segment numbers, different period identifiers, and/or the like. As such, an MPD coming from an origin B (e.g., computing device B, etc.) cannot be offered/used as an update for an MPD coming from an origin A (e.g., computing device A, etc.).

To allow for such functionality, there is an “MPD reset” option, where the MPD signals a “fresh start” and is not a mere continuation of the previous one. In the case of redundant computing devices (e.g., origin A and origin B, etc.), both MPDs include the start of the first periods in the past, so in this case, the ISO/IEC 23009-1 5^{th} edition (ed.) specification recommends canceling decoding of all upcoming samples and starting the playback of the new MPD. If this is done, there will be a period during which the existing segment buffer of the user device (DASH client) will be filled, and a Digital Rights Management (DRM) license would be requested. Playback would stall for this period, resulting in a poor user experience.

Additional signaling is disclosed herein to indicate a degree of continuity during an MPD reset. The reset itself may be signaled in the specification as an XML element (e.g., a continuity element). XML attributes or child elements of this XML element may be used to signal properties such as asset continuity, service continuity, and/or content protection continuity. Asset continuity implies that samples (e.g., video or audio frame) with the same wall-clock presentation time are perceptually identical. The user device (DASH client) reading this signal will maintain its current buffer (downloaded from origin A) and append new segments (downloaded from origin B) to it. If segment start times (translated into wall clock time) are different, there may be a brief (less than one segment duration, which typically is 2 seconds) gap between the end of the last segment from origin A and the new segment from origin B.

Service continuity implies that adaptation set, representation, and sub-representation IDs are identical across the new (from Origin B) and old (from Origin A) representations of the content.

Content Protection continuity implies that the same license is valid for the same content, and the key acquired using the information from Origin A is the same for the corresponding sample from Origin B as long as their key IDs are the same. The user device (DASH client) reading this signal during an MPD reset will attempt to continue using its current DRM context rather than tear it down and request the new license.

In case an MPD update is performed using the MPD Patch functionality, similar logic may be used. In this case, the MPD patch may be configured to comprise the continuity element in a replace element.

The above approaches are not limited to linear programming—a dynamic MPD may be used with video-on-demand (VOD) content. For example, the MPD may be requested with HTTP conditional requests to avoid the redundant download of identical MPDs.

FIG. 1 shows a system 100 for content delivery session recovery. When streaming media content (e.g., streaming video/audio, video-on-demand (VOD), multimedia, etc.) from a computing device (e.g., encoder, packager, origin server, HTTP server, etc.), a user device (e.g., a content/media player, a client device, a smart device, a mobile device, etc.) may experience fluctuations in network bandwidth. One way of dynamically adjusting an ongoing stream in the presence of such network bandwidth fluctuations is adaptive bitrate (ABR) streaming. In ABR streaming, the user device requests a data file (e.g., a media presentation description (MPD) file, a manifest file, etc.) from the computing device. The data file may include information about different “representations” or “renditions” of a content item that are available for adaptive bitrate streaming. Each representation may have different audio and/or video properties, and therefore certain representations may be more preferable than others for streaming in certain network bandwidth conditions. The user device may select a particular representation of the content item and may then request “chunks” (e.g., portions/segments, etc.) of the selected representation from the computing device. When network bandwidth changes, the user device may switch to a different representation.

Various ABR streaming protocols have been established (or are under discussion by industry standardization bodies). For example, ABR streaming protocols may include, but are not limited to, Apple® hypertext transfer protocol (HTTP) live streaming (HLS), HTTP dynamic streaming (HDS), smooth streaming, and MPEG dynamic adaptive streaming over HTTP (MPEG-DASH). MPEG-DASH is also known as the international organization for standardization (ISO)/international electrotechnical commission (IEC) 23009-1. In the case of MPEG-DASH, a data file may be referred to as a media presentation description (MPD) file, or MPD.

The system 100 may be used for content delivery. For example, the system 100 may be a dynamic adaptive streaming over HTTP (DASH) system/environment, that supports various forms of content delivery such as streaming/live content delivery (e.g., HTTP Live Streaming (HLS), etc.), video-on-demand (VOD) content delivery, and/or the like. The system 100 may be used to deliver content to a user device 101 (e.g., a content/media player, a client device, a smart device, a mobile device, etc.) via a network 104. The user device 101 may implement video compression techniques, such as those described in the standards defined by ITU-T Rec. H.264/MPEG-4 Advanced Video Coding (AVC), the ITU-T Rec. H.265High-Efficiency Video Coding (HEVC) standard, MPEG VVC, MPEG EVC, MPEG LCEVC, AOM AV1, VP9, JPEG-XS, etc. and extensions of such standards, to transmit and receive content, such as digital video information, more efficiently. The user device 101 may implement/employ any suitable standardized or proprietary compression techniques. The system may include any number of user devices configured and/or operating as the user device 101.

The network 104 may be a network, such as the Internet and/or the like. The network 104 may include a content delivery network, a content access network, and/or the like. The content delivery network and/or content access network may be managed (e.g., deployed, serviced) by a content provider, a service provider, and/or the like. The network 104 may include an optical fiber network, a coaxial cable network, a hybrid fiber-coaxial network, a wireless network, a satellite system, a direct broadcast system, or any combination thereof. The network 104 may be configured to provide content from a variety of sources using a variety of network paths, protocols, devices, and/or the like.

The network 104 and devices/components of the system 100 may support digital audio/video compression such as MPEG, or any other type of compression may be used for content delivery session recovery. The Moving Pictures Experts Group (MPEG) was established by the International Standards Organization (ISO) for the purpose of creating standards for digital audio/video compression. The MPEG experts created the MPEG-1, MPEG-2, MPEG-4, MPEG-H, VVC, LCEVC, and EVC standards. The combined MPEG-1, MPEG-2, and MPEG-4 standards are hereinafter referred to as MPEG. In an MPEG encoded transmission, content and other data are transmitted in packets, which collectively make up a transport stream. Additional information regarding transport stream packets, the composition of the transport stream, types of MPEG tables, and other aspects of the MPEG standards are described below. Transmission of MPEG packets and/or related data files, such as manifest files, MPDs, and/or the like may be employed to implement content delivery session recovery. However, content delivery session recovery may be implemented using other types of transmission and data.

The output of a transcoder may be an MPEG-2 transport stream with a video and/or an audio elementary stream transmitted using protocols such as UDP, SRT, RTP, or RIST, or ISO-BMFF transmitted using protocols such as DASH-IF Live Ingest or ATSC ROUTE, or passed to an HTTP server to be requested by the packager or the user device 101.

An elementary stream is an extended, near real-time, signal. For convenience, the elementary stream may be broken into data blocks of manageable size, forming a packetized elementary stream (PES). These data blocks need header information to identify the start of the packets and must include time stamps because packetizing disrupts the time axis. For transmission and digital broadcasting, several programs and their associated PESs may be multiplexed into a multi-program transport stream. A multi-program transport stream has a program clock reference (PCR) mechanism that allows the transmission of multiple clocks, one of which is selected and regenerated at the decoder.

A multi-program transport stream is more than just a multiplex of audio and video PESs. In addition to the compressed audio, video, and data, a transport stream may include metadata describing the bit stream. The metadata may include the program association table (PAT) that lists every program in the multi-program transport stream. Each entry in the PAT points to a program map table (PMT) that lists the elementary streams making up each program. Some programs may be unencrypted, but some programs may be subject to conditional access (encryption) and this information may also be carried in the metadata. The transport stream may be comprised of fixed-size data packets, each containing 188 bytes. Each packet may carry a program identifier code (PID). Packets in the same elementary stream may all have the same PID, so that the decoder (or a demultiplexer) may select the elementary stream(s) it wants and reject the remainder. Packet continuity counts ensure that every packet that is needed to decode a stream is received. A synchronization system and/or continuity element may be used so that transcoders (e.g., computing devices 102 and 103, etc.) may correctly identify the beginning of each packet and deserialize the bit stream into words.

A content item (e.g., streaming video/audio, video-on-demand (VOD), multimedia, etc.), such as a program, may be a group of one or more PIDs that are related to each other. For instance, a multi-program transport stream used in digital television might contain three programs, to represent three television channels. Suppose each channel consists of one video stream, one or two audio streams, and any necessary metadata. A receiver (e.g., user device 101, etc.) wishing to tune to a particular “channel” merely has to decode the payload of the PIDs associated with its program. It may discard the contents of all other PIDs.

The multi-program transport stream carries many different programs and each may use a different compression factor and a bit rate that may change dynamically even though the overall bit rate stays constant. This behavior is called statistical multiplexing and it allows a program that is handling difficult material to borrow bandwidth from a program handling easy material. Each video PES may have a different number of audio and data PESs associated with it. Despite this flexibility, a decoder must be able to change from one program to the next and correctly select the appropriate audio and data channels. Some of the programs may be protected so that they may only be viewed by those who have paid a subscription or fee. The transport stream may comprise Conditional Access (CA) information to administer this protection. Content delivered to a user device 101 may be derived from a plurality of sources, such as live content source, a video-on-demand (VOD) content source, an advertisement content source, and/or a computing device (e.g., encoder, packager, origin server, HTTP server, etc.), such as the computing device 102 and computing device 103. The system 100 may include any number of computing devices.

A control device 105 (e.g., a server, a computing device, a controller, etc.) may control and/or monitor, and/or permit a system operator to control/monitor, the functions and performance of system 100. The control device 105 may provide input to the modulators for setting operating parameters, such as system-specific MPEG table packet organization or conditional access information.

The control device 105 may be configured to exchange information between computing devices, such as the computing devices 102 and 103. The control device 105 may interface may inform (e.g., send a signal informing, etc.) a computing device, such as a computing devices 102 and 103, of the presence of another computing device. The control device 105 may determine that the computing device 102 is associated with the computing device 103. The control device 105 may be configured to serve as a load balancer between the computing devices 102 and 103. In some instances, the control device 105 may monitor and/or determine conditions affecting the system 100 and/or network 104, such as latency, errors, load balancing, and/or the like to determine a computing device best suited to support the user device 101 for a content delivery session. For example, the control device 105 may determine that given certain network conditions, such as where the computing devices are physically located with the network 104, to determine that the computing devices 102 and 103 may operate as redundant origins for content delivery to the user device 101.

The control device 105 may determine continuity between a representation of a content item located at and/or originating from the computing device 102 and a representation of the content item located at the computing device 103. The control device 105 may determine a continuity element, such as a XML element, to be used by the computing devices 102 and 103 when generating data files (e.g., media presentation description (MPD) files, manifest files, etc.) for different representations of content item to invoke continuity between the representations. A data file may be encoded with a continuity element. A continuity element enables switching between sources/origins, such as the computing devices 102 and 103. For example, if a content delivery session is interrupted, the session may be recovered with a reduced and/or minimal amount of downtime. The continuity element may enable the user device 101 and/or an intermediate device (e.g., a just-in-time (JIT) packager, a server, an intermediate device 106, etc.) to receive a content item (e.g., representations of the content item, etc.) from an alternate and/or substitute source/origin in the event that an original source/origin of the content item fails and/or is otherwise unavailable. For example, if a content delivery session, where representations of a content item are obtained from the computing device 102, fails and/or is interrupted, the session may be recovered with minimal downtime by obtaining representations of the content item from the computing device 103.

The continuity element may indicate continuity between representations of the content item. Continuity between representations of the content item may be associated with a perceptual continuity/similarity between representations of the content item. For example, continuity between representations of the content item may imply that portions/segments of different representations of the content item with matching timing information (e.g., wall clock, etc.) are perceptually identical. Continuity between representations of the content item may imply that one or more identifiers, indicators, and/or the like associated with the content item match (e.g., are identical) among components of the content item, such as adaptation sets, representations, and sub-representation. Continuity between representations of the content item may imply that security elements/information, such as licenses (e.g., a digital rights management (DRM) license, key identifiers, etc.), authorizations, and/or the like, between representations of the content are valid and/or shared.

The computing devices 102 and 103 may be configured to provide content (e.g., streaming video/audio, video-on-demand (VOD), multimedia, etc.) to the user device 101. The computing devices 102 and 103 may be managed by third party content providers, service providers, online content providers, over-the-top content providers, and/or the like. The computing devices 102 and 103 can divide each of the representations of a content item into “chunks,” such as a respective plurality of portions/segments. Each of the portions/segments can correspond to a particular duration of content (e.g., one second of content, two seconds of content, five seconds of content, etc.). Each of the portions/segments can be identified using a file name. The file name can include an identifier of the particular representation of a content item to which it corresponds.

The computing devices 102 and 103 may generate data files (e.g., media presentation description (MPD) files, manifest files, etc.) that facilitate access to the respective plurality of portions/segments for each of the plurality of representations of a content item (e.g., in response to a request for the content item, etc.). The data file can be generated as a tree or other hierarchy of elements. For example, for streaming content using DASH (Dynamic Adaptive Streaming over HTTP), the data file can include a Period element that describes a particular duration of the content item, such as a duration of the content item bound by a start time and an end time. The Period element can include, as child elements, Representation elements that identify each representation of the content item available during the duration. The Representation elements may describe various attributes of the corresponding representation of the content item, allowing for a user device 101 to select a representation for streaming based on capabilities of the user device 101, such as display resolution, supported file formats, and/or network conditions, such as available bandwidth.

For example, the system 100 may include the intermediate device 106 (e.g., a just-in-time (JIT) packager, server, etc.). The intermediate device 106 may be located in a region proximate to the user device 101. The intermediate device 106 may receive data files (e.g., media presentation description (MPD) files, manifest files, etc.) and content (e.g., a content item, representations of a content item, etc.) and streams from the computing devices 102 and 103 and perform content format conversions, such as conversions from DASH format streams to specific user device (client) formats. The intermediate device 106 may be configured to package content items for delivery to the user device 101 (e.g., in a specific format requested by a user device 101, etc.).

The intermediate device 106 may cache or otherwise store content (e.g., frequently requested content) to enable faster delivery of content to users. For example, the intermediate device 106 can receive a plurality of representations of a content item. Each of the plurality of representations corresponds to a version of the same content item (e.g., the same episode of a television show, the same movie). Each of the plurality of representations may differ from others of the plurality of representations by one or more attributes, such as a different file format, a different bit rate, or a different language. The plurality of representations can be received from the computing devices 102 and 103. For example, a request for a content item the user device 101 may be directed to the intermediate device 106 (e.g., due to the location of the intermediate device 106 and/or network conditions). The user device 101 may request a data file, such as an MPD, so that it may retrieve portions/segments of the content item. The intermediate device 106 may, for example, request an intermediate data file, such as an intermediate MPD, from the computing device 102 (origin A). If the intermediate device 106 is unable to retrieve an intermediate MPD from the computing device 102 (origin A), the intermediate device 106 may retrieve an intermediate MPD from the computing device 103 (origin B). The intermediate device 106 may add MPD reset signaling to a user/client-facing MPD derived from the intermediate MPD from the computing device 103 (origin B).

When an MPD is used for content delivery between a linear packager, such as the computing devices 102 and 103, and the intermediate device 106, the intermediate device 106 can insert an indication (e.g. a SupplementalProperty element, etc.) of whether the transcoders are synchronized, in terms of segment boundaries, timestamps, and wall-time clocks. When the transcoders are synchronized, an additional continuity property and/or attribute, time alignment (e.g., @timealignment, etc.), may be added that indicates that the timing between transcoders is continuous and only segment URLs at the different transcoders will be different.

The user device 101 may, when requesting a content item, receive a data file, such as an MPD, containing metadata for the various sub-streams of the content item that are available. The user device 101 may parse the data file and determine the “chunks” to request based on the playlist in the data file, capabilities/resources of the user device 101, and/or available network bandwidth. The user device 101 may fetch a first portion/segment of the content item posted at a computing device/origin, such as the computing device 102 and/or computing device 103, for playback. For example, the user device 101 may use HTTP Get requests to request a first portion/segment of a content item. During playback of the portion/segment, the user device 101 may fetch a second portion/segment of the content item for playback after the first portion/segment, and so on until the end of the content item. The process may continue for as long as the content item is being played (until the content item completes or the user device 101 tunes away). For a live content item, the respective data file may be continually updated as live content/media is being made available.

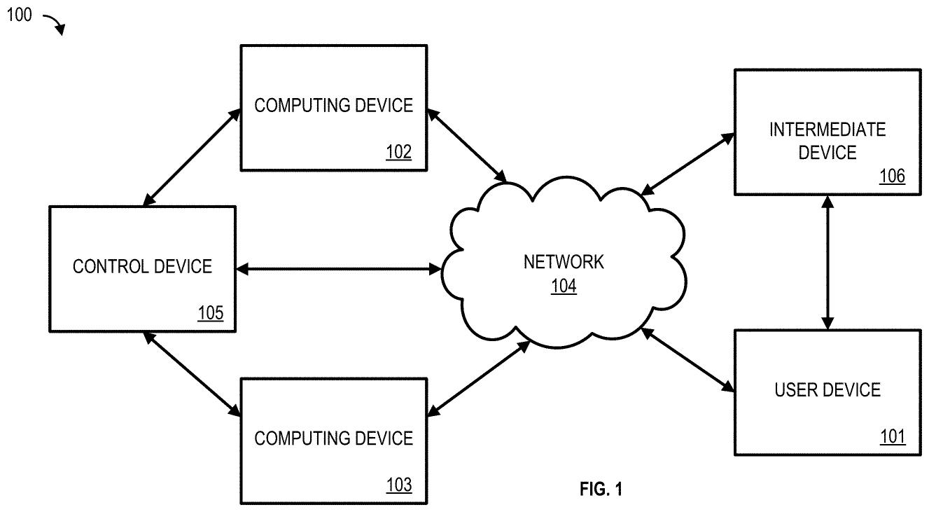

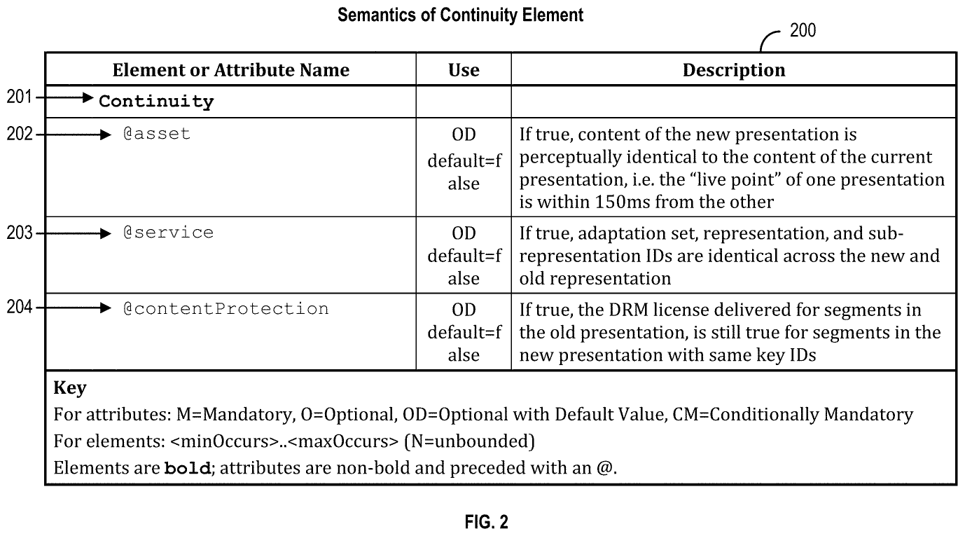

FIG. 2 shows a table 200 for the semantics of a continuity element. The continuity element describes various aspects that are maintained across representations of a content item described by successive data files (MPDs) in a scenario where an interruption occurs during delivery of a content item, for example, while the user device 101 and/or intermediate device 106 is requesting/receiving a representation of the content item. A Continuity element 201 may be embedded inside a SupplementalProperty or EssentialProperty element with @schemeldUri attribute values of urn:mpeg:dash:fallback:2016 or urn:mpeg:dash:reset:2016.

The Continuity element 201 may include an asset attribute 202. The asset attribute 202 may be set to an asset value. The asset value, based on its setting (e.g., asset value=true, asset value=false, etc.) may indicate that a representation of the content item at and/or provided by the computing device 102 is perceptually identical to a representation of the content item at and/or provided by the computing device 103. The Continuity element 201 may include a service attribute 203. The service attribute 203 may be set to a service value. Based on its setting (e.g., service value=true, service value=false, etc.), the service attribute 203 may indicate that one or more identifiers associated with a representation of the content item at and/or provided by the computing device 102 matches one or more identifiers associated with a representation of the content item at and/or provided by the computing device 103 (or vice versa). The Continuity element 201 may include a content protection attribute 204. The content protection attribute 204 may be set to a content protection value. Based on its setting (e.g., content protection value=true, content protection value=false, etc.), the content protection attribute 204. may indicate whether a security element (e.g., a DRM license, license, security key, etc.) associated with the representation of the content item at the computing device 102 is valid for the representation of the content item at the computing device 103 (or vice versa).

In some instances, The Continuity element 201 may include a time alignment attribute (not shown). For example, when transcoders of linear packagers (e.g., the computing devices 102 and 103, etc.) are synchronized, an additional continuity property, such as @timealignment, may be added to an MPD to indicate that the timing between the transcoders is continuous and only segment resource locators and/or references (e.g., URLs, etc.) at the different transcoders will be different.

Returning to FIG. 1, a continuity element (e.g., the Continuity element 201) may be used to control how the user device 101 (and/or the intermediate device 106) responds to an interruption to content delivery. For example, in case of an interruption to content delivery caused by a failure of the source/origin of the representation (e.g., the computing device 102, etc.), the continuity element may instruct the user device 101 to maintain any portion/segment of a representation of the content item that has already been received (e.g., stored in a buffer of the user device 101, etc.) and request additional portions/segments of another representation of the content item from a different source/origin (e.g., the computing device 103, etc.), which may minimize the duration of the interruption to content delivery.

In case of an interruption to content delivery caused by a failure of the source/origin of the representation (e.g., the computing device 102, etc.), the continuity element may instruct the intermediate device 104 to maintain, play, and/or send to the user device 101 any portion/segment of a representation of the content item that has already been received/downloaded from a source/origin (e.g., the computing device 102, etc.) while receiving/downloading any additional portions/segments of the content item from a different source/origin (e.g., the computing device 103, etc.), and play, and/or send to the user device 101 the additional portions/segments of the content item.

In case of an interruption to content delivery caused by a failure of the source/origin of the representation (e.g., the computing device 102, etc.), the continuity element may instruct the user device 101 and/or intermediate device 104 to continue receiving representations of the content item (e.g., continue a session, etc.) using a current security element (e.g., DRM license, etc.) instead of requesting a new security element before receiving representations of the content item from a different source/origin, which may minimize the duration of the interruption to content delivery.

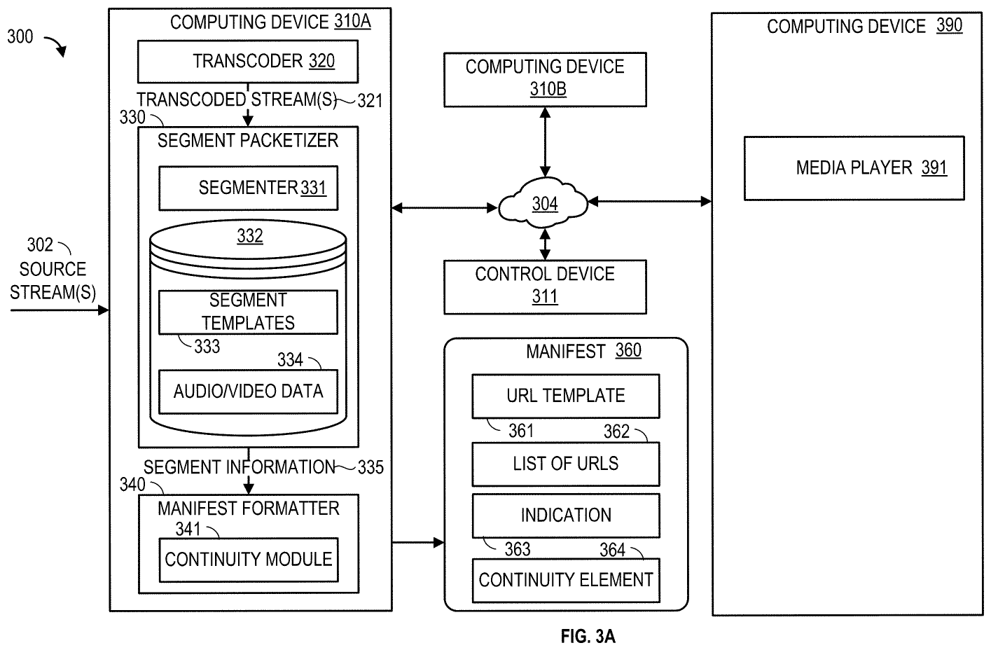

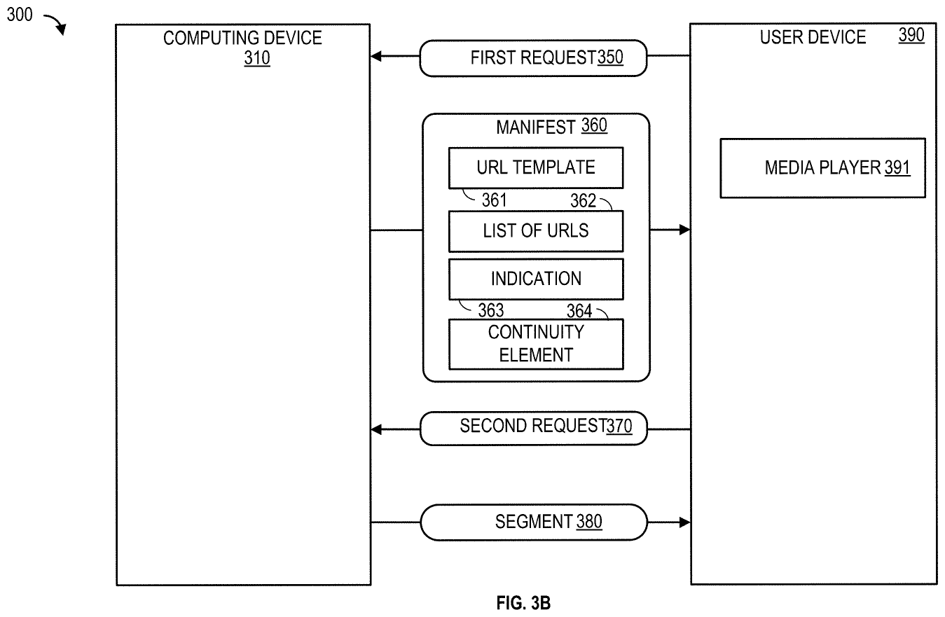

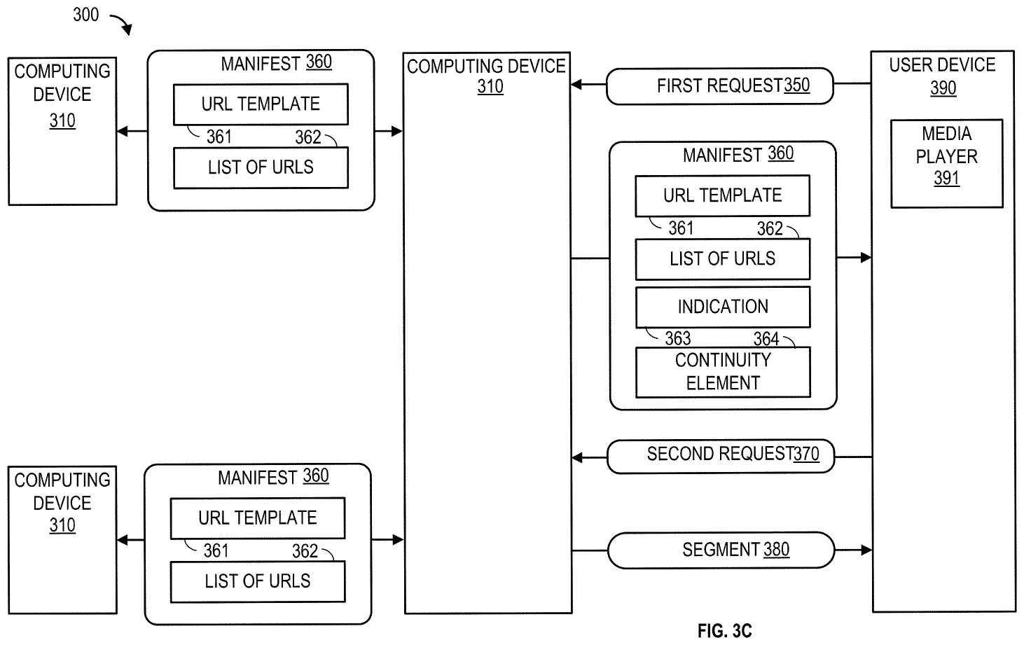

FIG. 3A shows a system 300 that is operable to perform manifest generation, segment packetization, and/or content delivery session recovery. The system 300 may comprise a computing device 310A (e.g., an encoder, a packager, an origin server, an HTTP server, the computing device 102, the computing device 103, etc.) that is communicably coupled to a user device 390 (e.g., a content/media player, a client device, a smart device, a mobile device, the user device 101, etc.). For example, the computing device 310A and the user device 390 may communicate via a network, such as a local area network (LAN), a wide area network (WAN), and/or the Internet. It should be noted that although a single computing device 390 is shown in FIG. 3A, this is not to be considered limiting. For example, the computing device 310A may provide manifests and/or segments/packets to any number of user devices 390.

The computing device 310A may comprise a media server. The computing device 310A may comprise a transcoder 320, a segment packetizer 330, and/or a manifest formatter 340, each of which may correspond to hardware, software (e.g., instructions executable by one or more processors of the computing device 310A), or a combination thereof. Although FIG. 3A shows the computing device 310A including the transcoder 320, in an alternate embodiment the computing device 310A does not include the transcoder 320. When included, the transcoder 320 may be configured to perform bitrate conversion, coder/decoder (CODEC) conversion, frame size or resolution conversion, etc. For example, the computing device 310A may receive a source stream 302 and the transcoder 320 may transcode the source stream 302 to generate one or more transcoded streams 321. The source stream 302 may be a live stream or a video-on-demand (VOD) stream. In a particular embodiment, the computing device 310A may be configured to receive the source stream 302 from an external source (e.g., a stream capture source, a data storage device, another media server, etc.). The computing device 310A may be configured to receive the source stream 302 via a wired or wireless network connection. The source stream 302 may be generated by the computing device 310A. The source stream 302 may correspond to a video-on-demand (VOD) content item that is stored at the computing device 310A (e.g., a television show, a movie, a digital video recorder (DVR) recording of a previously received live stream, etc.). It should be noted that although a single source stream 302 is shown in FIG. 3A, this is not to be considered limiting. For example, the computing device 310A may receive any number of source streams 302.

One or more transcoded streams 321 may correspond to a different adaptive bitrate (ABR) representation of the source stream 302. For example, the transcoded streams 321 may differ from each other with respect to one or more of audio bitrate, a number of audio channels, audio CODEC, video bitrate, video frame size, video resolution, video CODEC, etc. The one or more transcoded streams 321 may be made available to user devices (e.g., the user device 390) for adaptive streaming, as further described herein.

For example, a single high bitrate source video/audio stream 302 may be used to generate one or more representations of a content item that have lower bitrates and/or alternative CODECs on-the-fly. As an example, audio formats may be switched from both CODEC and from a surround sound format to a stereo format, such as a switch from 5.1 channel E-AC-3 to 2-channel AAC. The transcoder 320 may be configured to transcode the incoming source stream 302 such that key frames (e.g., intra-coded frames (IDR or non-IDR I-frames)) in each of the transcoded streams 321 occur at the same time. That is, each of the transcoded streams 3121 may be “key frame aligned” to enable seamless switching between different ABR representations by a destination device (e.g., the user device 390).

The segment packetizer 330 may comprise a segmenter 331. The segment packetizer 330 may also include (or have access to) a data storage device 332, as shown. The segmenter 331 may divide a set of ABR representations (e.g., the transcoded streams 321) into media segments. For example, the segmenter 331 may receive a target segment duration. The target duration may be, for example, approximately two or ten thousand milliseconds. The target segment duration may be received via user input or a configuration file or API call at the computing device 310A. Alternately, the target segment duration may be dynamically determined based on properties of the source stream 302, the computing device 310A, etc. For example, if the target segment duration is ten seconds, the segmenter 331 may process the incoming transcoded streams 321 and break the transcoded streams 321 into segments at key frame boundaries approximately ten seconds apart. Further, if the transcoded streams 321 include separate video and audio streams, the segmenter 331 may generate the segments such that the video and audio streams are timecode aligned.

The computing device 310A may be configured to support multiple content segmentation types. The segmenter 331 may be configured to generate segments for each of the content segmentation types supported by the computing device 310A. Segments may alternately be referred to as “chunks.” The computing device 310A may be configured to support both multiplexed segments (video and audio data included in a single multiplexed stream) and non-multiplexed segments (video and audio data included in separate non-multiplexed streams). Further, in the case of MPEG-DASH, the computing device 310A may be configured to support container formats in compliance with standards such as international standards organization base media file format (ISO-BMFF), motion picture experts group 2 transport stream (MPEG-TS), extensible binary markup language (EBML), WebM, Matroska, or any combination thereof.

The segmenter 331 may be configured to employ a “smart” storage system to avoid replicating audio/video data when generating segments for each content segmentation type. In one example, if the computing device 310A supports N content segmentation types (where N is an integer greater than zero), the segmenter 331 may generate N segment templates 333 for each segment (e.g., ten-second portion) of each of the transcoded streams 321. Each segment template 333 may comprise header information associated with a content segmentation type, data indicating a start position or start time of the segment in the source stream 302, and data indicating an end position or end time of the segment in the source stream 302. Thus, in the case of MPEG-DASH, different segment templates may be generated for ISOBMFF multiplexed (“muxed”), ISOBMFF non-multiplexed (“demuxed”), MPEG-TS muxed, MPEG-TS demuxed, EBML muxed, EBML demuxed, etc. In an embodiment, each of the segment templates 333 may not include the underlying audio/video data 334 of the corresponding segment. Thus, even though multiple segment templates 333 may be generated for each segment of the source stream 302, the underlying segment audio/video data 334 may be stored once. As the segment templates 333 are generated, the segmenter 331 may generate and provide segment information 335 regarding the segment templates 333 to a manifest formatter 340.

During operation, the manifest formatter 340 may be configured to generate one or more manifests based on the segment information 335 received from the segment packetizer 330. In the case of MPEG-DASH, the manifest may be a MPEG-DASH media presentation description (MPD) file. The manifest formatter 340 may be configured to generate one or more manifests based on a manifest type and/or a content segmentation type. If the manifest type is number-based or time-based, the manifest formatter 340 may be configured to generate, based on the segment information 335, a manifest 360 that comprises a URL template 361. The URL template 361 may be number-based or time-based. The URL template 361 that is number-based may be used by the user device 390 to construct URLs to request individual segments by segment number. The URL template 361 that is time-based may be used by the user device 390 to construct URLs to request individual segments by segment start time or number. If the manifest type is list-based, the manifest formatter 340 may be configured to generate, based on the segment information 335, a manifest 360 that comprises a list of URLs 362. The list of URLs may include URLs specific to one or more segments of one or more ABR representations.

The manifest 360 may identify one or more segments of one or more adaptive streaming representations of the source stream 302. As an example, the transcoded streams 321 generated by the transcoder 320 may include three ABR representations of the source stream 302: a first representation with a bit rate of 2 megabits per second (Mbps) and a resolution of 1280×720, a second representation with a bit rate of 750 kilobits per second (Kbps) and a resolution of 960×540, and a third representation with a bit rate of 250 kbps and a resolution of 640×360. In an embodiment, more, fewer, and/or different adaptive streaming representations may be generated by the transcoder 320, where each generated adaptive streaming representation(s) has a plurality of key frame-aligned segments. Thus, the manifest formatter 340 may generate manifests based on the segment information 335 from the segment packetizer 330, including information regarding the segment(s) of the adaptive streaming representation(s) generated by the transcoder 320.

A different manifest may be generated for each client (e.g., media player 391 and/or user device 390) that requests a manifest, even if two clients specify the same manifest type and content segmentation type. Thus, the manifest 360 may be specific to the media player 391 and/or the user device 390. Each URL or URL template in the manifest 360 may include embedded session information that identifies the media player 391 and/or the user device 390. The session information may be used to uniquely identify the requester of a segment. Thus, by generating a different manifest for each client, the computing device 310A may track various items (e.g., number of segments, number of ABR representation switches, etc.) on a per-client basis.

In an embodiment, the manifest formatter 340 may comprise a continuity module 341. The continuity module 341 may be configured to communicate with a control device 311 and/or one or more other computing devices 310B. The control device 311 may be configured to exchange information between computing devices 310A. The control device 311 may be configured to serve as a load balancer between computing devices 310A. The one or more other computing devices 310B may be configured to perform some or all of the functionality of the computing device 310A as described herein.

The continuity module 341 may be configured to determine and/or receive an indication of one or more computing devices 310B. The indication of the computing device 310B may be received from the control device 311. The indication of the computing device 310B may indicate an association or relationship between the computing device 310A and the computing device 310B. For example, the computing device 310 may serve as a backup for the computing device 310B and the computing device 310B may serve as a backup for the computing device 310A in the event one of the computing device 310A or the computing device 310B fails or is otherwise unable to process a request. The continuity module 341 may be configured to insert an indication 363 of the computing device 310B into the manifest 360. The indication 363 may comprise an identifier, an address, and/or the like of the computing device 310B.

The continuity module 341 may be configured to determine and/or receive data and/or information associated with continuity between a representation of a content item located at the computing device 310A and a representation of the content item located at the computing device 310B. The data and/or information associated with the continuity between the representation of a content item located at the computing device 310A and the representation of the content item located at the computing device 310B may comprise an asset value, a service value, and/or a content protection value.

The asset value may indicate whether the representation of the content item at the computing device 310A is perceptually identical to the representation of the content item located at the computing device 310B. A representation of a content item may be considered as perceptually identical (for switching purpose) to another representation of the content item if a live point of one representation is within a threshold amount of time from the other representation. For example, the threshold amount of time may be from, and include, about 1 millisecond to about 500 milliseconds. In an embodiment, the threshold amount of time is 150 milliseconds. By way of example, the asset value may be indicated as true or false.

The service value may indicate that one or more identifiers associated with the representation of the content item at the computing device 310A match one or more identifiers associated with the representation of the content item located at the computing device 310B. For example, the service value may indicate whether an adaptation set, representation, and/or sub-representation identifiers are identical between the representation of the content item at the computing device 310A and the representation of the content item located at the computing device 310B. By way of example, the service value may be indicated as true or false.

The content protection value may indicate whether a license associated with the representation of the content item at the computing device 310A is valid for the representation of the content item at the computing device 310B. By way of example, the content protection value may be indicated as true or false.

The continuity module 341 may be configured to determine a continuity element 364 based on one or more of the asset value, the service value, and/or the content protection value and insert the continuity element 364 into the manifest 360. In the case of MPEG-DASH, the continuity element 364 may comprise an Extensible Markup Language (XML) element.

As shown in FIG. 3B, the computing device 310A may receive a first request 350 from the computing device 390. In a particular embodiment, the MPEG-DASH MPD may be requested via a URL.

To illustrate, a media player 391, such as a MPEG-DASH compliant media player, may send a first request 350 for a manifest associated with the source stream 302. In an example, the first request 350 may be sent in response to a user of the user device 390 selecting a URL.

The computing device 310A may send the manifest 360 to the media player 391. The media player 391 may use the manifest 360 to send a second request 370 to the computing device 310A. In response to the second request 370, the computing device 310A may determine and/or generate a corresponding segment 380 of the content item and send the segment 380 to the user device 390. For example, segment 380 may be generated based on one of the segment templates 333 and may include selected data from the audio/video data 334. In a particular embodiment, the segment 380 may also be stored in a cache at the computing device 310A for subsequent retrieval (e.g., in response to a request for the segment 380 from another computing device). As additional computing devices (not shown) connect to the computing device 310A to access the source stream 302, the computing device 310A may provide manifests and requested segments to the additional computing devices.

In a particular embodiment, when the computing device 310A and the computing device 390 communicate via a MPEG-DASH protocol, the computing device 310A may provide one or more types of files to the computing device 390. The first type of file may comprise a MPEG-DASH MPD file, such as the manifest 360. As explained above, a MPEG-DASH MPD file can correspond to various manifest types and content segmentation types. The second type of file may comprise a MPEG-DASH media segment, such as the segment 380. A MPEG-DASH media segment includes audio and/or video data for a stream. MPEG-DASH media segments can be in different formats, including but not limited to ISOBMFF, MPEG-TS, and WebM. Further, a MPEG-DASH media segment can contain muxed A/V data, only audio data, or only video data. The data may be encoded using a CODEC supported by MPEG-DASH, including but not limited to H.264, AAC, HEVC, VVC and E-AC-3. The third type of file may comprise a MPEG-DASH initialization segment. MPEG-DASH initialization segments may include data to initialize a media player (e.g., the media player 391) and/or to determine whether the media player is capable of decoding a stream. In a particular embodiment, after receiving the manifest 360, the computing device 390 may request at least one MPEG-DASH initialization segment before requesting any MPEG-DASH media segments. For example, a MPEG-DASH initialization segment may be received once per ABR representation. Thus, if the computing device 390 switches to a new ABR representation in response to a change in network conditions, a new MPEG-DASH initialization segment may be requested before requesting any MPEG-DASH media segments of the new ABR representation.

In an embodiment, a failure associated with either the computing device 310A or the computing device 310B may occur. For example, either the computing device 310A or the computing device 310B shuts down, becomes overloaded, is damaged, encounters network issues, and the like. In an embodiment, an MPD reset descriptor (e.g., a descriptor defined in section 5.4.2 of the MPEG DASH specification), may be used to signal a failure. In an embodiment, a failure may be signalled within a fallback MPD chaining descriptor (as defined in section 5.11.2 of the MPEG DASH specification). For example, the media player 391 may request a manifest (MPD) from the computing device 310A, the request will fail, and the media player 391 will request a fallback MPD. The same continuity properties as in MPD reset apply here as well; the only difference is that the media player 391 and not the computing device 310A discovers the failure.

Typically, in the event of a failure, an MPD reset option is used, wherein the MPD signals a “fresh start” rather than a continuation of the previous MPD. In case of redundant origins, both MPDs will have the start of the first periods in the past, so in this case the MPEG DASH specification recommends canceling decoding of all upcoming samples and starting the playback of the new MPD. If this is done, there will be a period during which the existing segment buffer of the DASH client will be filled, and the DRM license would be requested. Playback would stall for this period, resulting in a bad user experience.

However, as described herein, in the event of such a failure, the media player 391 may access the continuity element 364 to determine how to proceed. The media player 391 may access the continuity element 364 to determine values for the asset value, the service value, and/or the content protection value.

In an embodiment, the continuity element 364 may indicate that the asset value indicates that the representation of the content item at the computing device 310A is perceptually identical to the representation of the content item located at the computing device 310B. Accordingly, the media player 391 may output any buffered portions of the content item. The media player 391 may send a request to the computing device 310B for at least another portion of the content item. The media player 391 may receive and output the at least another portion of the content item.

In an embodiment, the continuity element 364 may indicate that the asset value indicates that the representation of the content item at the computing device 310A is not perceptually identical to the representation of the content item located at the computing device 310B. Accordingly, the media player 391 may output any buffered portions of the content item. The media player 391 may then output an indication that the content item is no longer available or output an alternative content item.

In an embodiment, the continuity element 364 may indicate that the service value indicates that one or more identifiers associated with the representation of the content item at the computing device 310A match one or more identifiers associated with the representation of the content item located at the computing device 310B. Accordingly, the media player 391 may output any buffered portions of the content item. The media player 391 may send a request to the computing device 310B for at least another portion of the content item. The media player 391 may receive and output the at least another portion of the content item.

In an embodiment, the continuity element 364 may indicate that that the service value indicates that one or more identifiers associated with the representation of the content item at the computing device 310A do not match one or more identifiers associated with the representation of the content item located at the computing device 310B. Accordingly, the media player 391 may output any buffered portions of the content item. The media player 391 may receive and output, based on a default service parameter, the at least another portion of the content item. The default service parameter may comprise at least one of, a default language, a default audio track, a default camera view, or a closed caption setting.

In an embodiment, the continuity element 364 may indicate that the content protection value indicates that a license associated with the representation of the content item at the computing device 310A is valid for the representation of the content item at the computing device 310B. Accordingly, the media player 391 may output any buffered portions of the content item. The media player 391 may send a request to the computing device 310B for at least another portion of the content item. The media player 391 may receive and output the at least another portion of the content item.

In an embodiment, the continuity element 364 may indicate that the content protection value indicates that a license associated with the representation of the content item at the computing device 310A is not valid for the representation of the content item at the computing device 310B. Accordingly, the media player 391 may output any buffered portions of the content item. The media player 391 may send, to a security computing device, a request for an encryption key associated with the representation of the content item at the computing device 310B. The media player 391 may receive, from the security computing device, the encryption key. The media player 391 may send the encryption key to the computing device 310B. The media player 391 may receive, based on the second request and the encryption key, at least another portion of the content item and output the at least another portion of the content item.

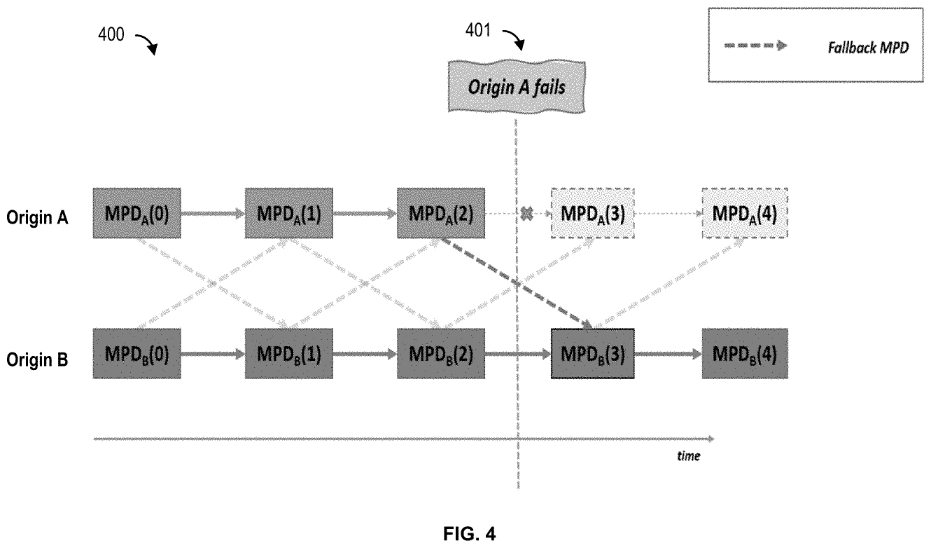

FIG. 4 shows an example content delivery session 400. The content delivery session 400 depicts an exchange of data files (e.g., MPDs) used by a user device (e.g., a content/media player, a client device, a smart device, a mobile device, the user device 101, user device 390, etc.). An Origin A (e.g., a computing device, an encoder, a packager, an origin server, a HTTP server, the computing device 310, etc.) may serve as a backup for an Origin B (e.g., a computing device, an encoder, a packager, an origin server, a HTTP server, the computing device 310, etc.) and the Origin B may serve as a backup for the Origin A in the event one of the Origin A or the Origin B fails or is otherwise unable to process request for MPDs from the user device.

The Origin A and the Origin B may both generate MPD files that the user device may request/download at different intervals during the content delivery session. For example, the Origin A may generate MPD_{A}(n) and the Origin B may generate MPD_{B}(n) that each correspond to representations of the content item at the respective origins. For example, MPD_{A}(0) may be generated by the Origin A at the start of the content delivery session and correspond to an initial portion/segment of the representation of the content item. The Origin A and the Origin B may be aware of each other. For example, the Origin A may be aware of the resource locator and/or reference (e.g., URL, etc.) associated with the Origin B, and the Origin B may be aware of the resource locator and/or reference (e.g., URL, etc.) associated with the Origin A. In some instances, the Origin A and Origin B may be aware of the synchronization status of each other. Accordingly, the Origin A and the Origin B may both generate MPDs insert the fallback MPD URL into the MPDs. For example, Each MPD generated by the Origin A and Origin B, respectively, may include an indication that the other origin is a backup. As indicated by the dashed lines a reference to a fallback MPD is references in each MPD generated by the Origin A and Origin B, respectively.

The Origin A may provide MPDs (e.g., MPD_{A}(0)-MPD_{A}(2)) to the user device at the regular intervals, and the Origin B may generate and store MPDs (e.g., MPD_{B}(0)-MPD_{B}(2)) until the Origin A fails at 401. For example, either the Origin A may shut down, become overloaded, be damaged, encounter network issues, and/or the like.

The user device and/or an origin may determine the failure 401. In an embodiment, an MPD reset descriptor (e.g., a descriptor defined in section 5.4.2 of the MPEG DASH specification), may be used to signal the failure 401. In an embodiment, the failure 401 may be signalled within a fall back MPD chaining descriptor (as defined in section 5.11.2 of the MPEG DASH specification). For example, the user device may request the next MPD (e.g., MPD_{A}(3)) in the sequence from the Origin A, the request will fail, and the user device will request a fallback MPD (e.g., MPD_{B}(3)) from the Origin B. The same continuity properties as in MPD reset apply in this situation. The only difference being that the user device and not the origin discovers the failure.

Typically, in the event of a failure, an MPD reset option is used, wherein the MPD signals a “fresh start” rather than a continuation of the previous MPD. In case of redundant origins, such as Origin A and Origin B, both MPDs (MPD_{A}(n) and MPD_{B}(n)) will have the start of the first periods in the past, so in this case the MPEG DASH specification recommends canceling decoding of all upcoming samples and starting the playback of the new MPD. If this is done, there will be a period during which the existing segment buffer of the DASH client will be filled, and the DRM license would be requested. Playback would stall for this period, resulting in a bad user experience.

To reduce the downtime caused by the failure 401, the MPDs (MPD_{A}(n) and MPD_{B}(n)) may be generated with a continuity element. The attributes of the continuity element may be used by the Origin A and the Origin B to signal content, live point, and content protection continuity between representations of the Origin A and the Origin B. The failure 401 may cause the user device to access the continuity element to determine how to proceed. The continuity element may instruct the user device to fetch a fallback MPD (MPD_{B}(3). If the continuity element is configured with an asset attribute value set to “true,” the continuity element may indicate that the representation of the content item at the Origin A is perceptually identical to the representation of the content item at Origin B. Accordingly, the user device may output any buffered portions of the content item. For example, if the continuity element is configured with an asset attribute value set to “true,” the user device will keep playing already downloaded content item segments from the Origin A, while downloading new content item segments from the Origin B. The user device will then switch to content item segments from the Origin B when downloaded segments from Origin A are available/presented. If the continuity element is configured with an asset attribute value set to “false,” the continuity element may indicate that the representation of the content item at the Origin A is not perceptually identical to the representation of the content item located at the Origin B. Accordingly, the user may output any buffered portions of the content item. The user device may then output an indication that the content item is no longer available or output an alternative content item.

If the continuity element is configured with a service attribute value set to “true,” the continuity element may indicate that the service value indicates that one or more identifiers associated with the representation of the content item at the Origin A match one or more identifiers associated with the representation of the content item located at the Origin B. Accordingly, the user device may output any buffered portions of the content item. The user device may send a request to the Origin B for at least another portion of the content item. The user device may receive and output the at least another portion of the content item.

If the continuity element is configured with a service attribute value set to “false,” the continuity element may indicate that the service value indicates that one or more identifiers associated with the representation of the content item at the Origin A do not match one or more identifiers associated with the representation of the content item located at the Origin B. Accordingly, the user device may output any buffered portions of the content item. The user device may receive and output, based on a default service parameter, the at least another portion of the content item. The default service parameter may comprise at least one of, a default language, a default audio track, a default camera view, or a closed caption setting.

If the continuity element is configured with a content protection attribute value set to “true,” the continuity element may indicate that the content protection value indicates that a security element (e.g., a DRM license, encryption key, etc.) associated with the representation of the content item at the Origin A is valid for the representation of the content item at the Origin B. The user device will continue receiving content item segments (e.g., continue the content delivery session, etc.) using the current security element (e.g., a DRM license, encryption key, etc.) instead requesting a new security element before receiving representations of the content item from a different source/origin, which may minimize the duration of the interruption to content delivery.

If the continuity element is configured with a content protection attribute value set to “false,” the continuity element may indicate that the content protection value indicates that a security element (e.g., a DRM license, encryption key, etc.) associated with the representation of the content item at the Origin A is not valid for the representation of the content item at Origin B. Accordingly, user device may output any buffered portions of the content item. The user device may send, to a security computing device, a request for an encryption key associated with the representation of the content item at the Origin B. The user device may receive, from the security computing device, the encryption key. The user device may send the encryption key to the Origin B. The user device may receive, based on another second request and the encryption key, at least another portion of the content item and output the at least another portion of the content item.

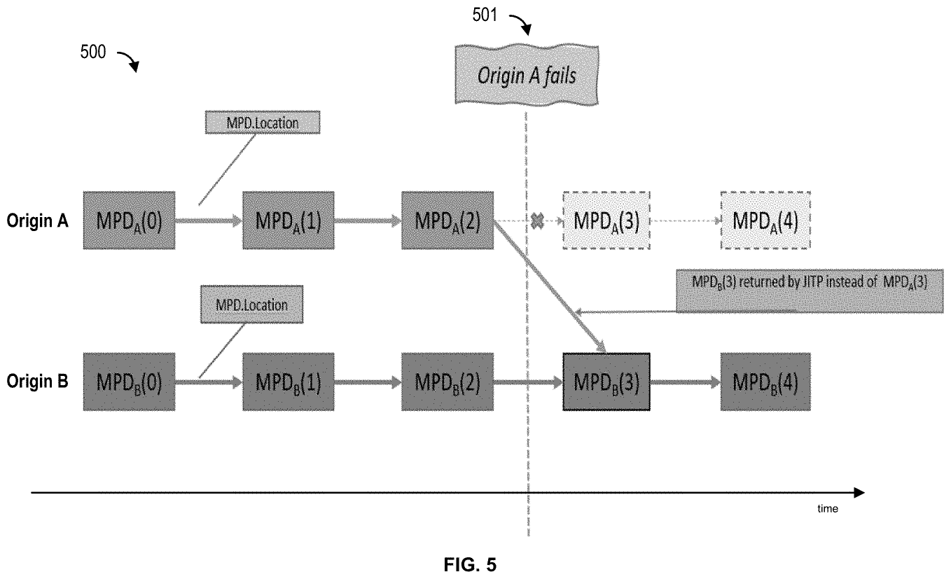

FIG. 5 shows an example content delivery session 500. The content delivery session 400 depicts an exchange of data files (e.g., MPDs) used by an intermediate device (e.g., a just-in-time (JIT) packager, a server, the intermediate device 106, the computing device 392, etc.). The intermediate device may serve as an intermediate for content delivery to a user device (e.g., a content/media player, a client device, a smart device, a mobile device, the user device 101, user device 390, etc.). To reduce bandwidth and network storage requirements, the intermediate device may prepare a content item (e.g., streaming video/audio, video-on-demand (VOD), multimedia, etc.) for delivery to the user device at the point when the user device requests the content item. The intermediate device may request a content item, on behalf of the user device, from an Origin A (e.g., a computing device, an encoder, a packager, an origin server, an HTTP server, the computing device 310, etc.), the intermediate device may generate the appropriate packages (data files), automatically, and select an appropriate media packaging and licensing formats (e.g., DRM formats, etc.).

The Origin A (e.g., a computing device, an encoder, a packager, an origin server, an HTTP server, the computing device 310, etc.) may serve as a backup for an Origin B (e.g., a computing device, an encoder, a packager, an origin server, an HTTP server, the computing device 310, etc.) and the Origin B may serve as a backup for the Origin A in the event one of the Origin A or the Origin B fails or is otherwise unable to process the request for MPDs from the user device.

The Origin A and the Origin B may both generate MPD files that the intermediate device may request/download at different intervals during the content delivery session. For example, the Origin A may generate MPD_{A}(n) and the Origin B may generate MPD_{B}(n) that each correspond to representations of the content item at the respective origins. For example, MPD_{A}(0) may be generated by the Origin A at the start of the content delivery session and correspond to an initial portion/segment of the representation of the content item. The Origin A and the Origin B may be aware of each other. For example, the Origin A may be aware of the resource locator and/or reference (e.g., URL, etc.) associated with the Origin B, and the Origin B may be aware of the resource locator and/or reference (e.g., URL, etc.) associated with the Origin A. In some instances, the Origin A and Origin B may be aware of the synchronization status of each other. Accordingly, the Origin A and the Origin B may both generate MPDs insert the fallback MPD URL into the MPDs. For example, Each MPD generated by the Origin A and Origin B, respectively, may include an indication that the other origin is a backup. As indicated by the dashed lines a reference to a fallback MPD is references in each MPD generated by the Origin A and Origin B, respectively.

The Origin A may provide MPDs (e.g., MPD_{A}(0)-MPD_{A}(2)) to the intermediate device at the regular intervals, and the Origin B may generate and store MPDs (e.g., MPD_{B}(0)-MPD_{B}(2)) until the Origin A fails at 501. For example, either the Origin A may shut down, become overloaded, be damaged, encounter network issues, and/or the like.

The user device may be unaware of the failure 501. The intermediate device and/or an origin may determine the failure 501. In an embodiment, an MPD reset descriptor (e.g., a descriptor defined in section 5.4.2 of the MPEG DASH specification), may be used to signal the failure 401. In an embodiment, the failure 401 may be signalled within a fallback MPD chaining descriptor (as defined in section 5.11.2 of the MPEG DASH specification). For example, the user device may request a next MPD, the intermediate device may request MPD_{A}(3) on behalf of the user device. If the intermediate device is unable to receive MPD_{A}(3), the intermediate device may use MPD_{A}(2) to request the fallback MPD, MPD_{B}(3). The intermediate device may add MPD reset signalling to the MPD provided to the user device. The MPD may signal a “fresh start” to the user device rather than a continuation of the previous MPD.

To reduce the downtime caused by the failure 501, The MPD generated and sent to the user device by the intermediate device may include a continuity element. The attributes of the continuity element may signal content, live point, and content protection continuity between representations of the Origin A and the Origin B. The MPD generated and sent to the user device by the intermediate device may instruct the user device how to proceed. If the continuity element is configured with an asset attribute value set to “true,” the continuity element may indicate that the representation of the content item at the Origin A is perceptually identical to the representation of the content item at Origin B. Accordingly, the user device may output any buffered portions of the content item. For example, if the continuity element is configured with an asset attribute value set to “true,” the user device will keep playing already downloaded content item segments from the Origin A, while downloading new content item segments from the Origin B. The user device will then switch to content item segments from the Origin B when downloaded segments from Origin A are available/presented. If the continuity element is configured with an asset attribute value set to “false,” the continuity element may indicate that the representation of the content item at the Origin A is not perceptually identical to the representation of the content item located at the Origin B. Accordingly, the user may output any buffered portions of the content item. The user device may then output an indication that the content item is no longer available or output an alternative content item.

If the continuity element is configured with a service attribute value set to “true,” the continuity element may indicate that the service value indicates that one or more identifiers associated with the representation of the content item at the Origin A match one or more identifiers associated with the representation of the content item located at the Origin B. Accordingly, the user device may output any buffered portions of the content item. The user device may send a request to the Origin B for at least another portion of the content item. The user device may receive and output the at least another portion of the content item.

If the continuity element is configured with a service attribute value set to “false,” the continuity element may indicate that the service value indicates that one or more identifiers associated with the representation of the content item at the Origin A do not match one or more identifiers associated with the representation of the content item located at the Origin B. Accordingly, the user device may output any buffered portions of the content item. The user device may receive and output, based on a default service parameter, the at least another portion of the content item. The default service parameter may comprise at least one of, a default language, a default audio track, a default camera view, or a closed caption setting.

If the continuity element is configured with a content protection attribute value set to “true,” the continuity element may indicate that the content protection value indicates that a security element (e.g., a DRM license, encryption key, etc.) associated with the representation of the content item at the Origin A is valid for the representation of the content item at the Origin B. The user device will continue receiving content item segments (e.g., continue the content delivery session, etc.) using the current security element (e.g., a DRM license, encryption key, etc.) instead of requesting a new security element before receiving representations of the content item from a different source/origin, which may minimize the duration of the interruption to content delivery.

If the continuity element is configured with a content protection attribute value set to “false,” the continuity element may indicate that the content protection value indicates that a security element (e.g., a DRM license, encryption key, etc.) associated with the representation of the content item at the Origin A is not valid for the representation of the content item at Origin B. Accordingly, a user device may output any buffered portions of the content item. The user device may send, to a security computing device, a request for an encryption key associated with the representation of the content item at the Origin B. The user device may receive, from the security computing device, the encryption key. The user device may send the encryption key to the Origin B. The user device may receive, based on another second request and the encryption key, at least another portion of the content item and output the at least another portion of the content item.

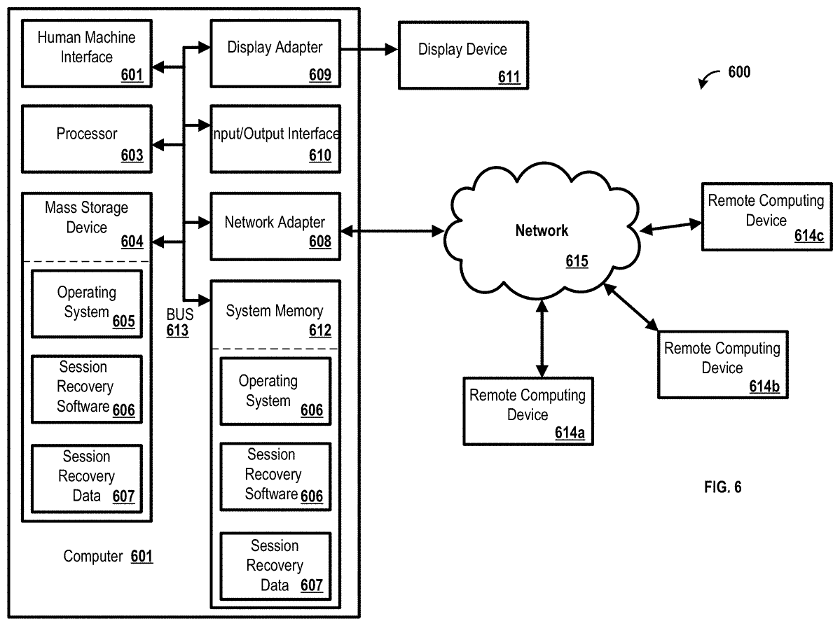

FIG. 6 shows a system 600 for content delivery session recovery. Any device and/or component described herein may be a computer 601 as shown in FIG. 6.

The computer 601 may comprise one or more processors 603, a system memory 612, and a bus 613 that couples various components of the computer 601 including the one or more processors 603 to the system memory 612. In the case of multiple processors 603, the computer 601 may utilize parallel computing.

The bus 613 may comprise one or more of several possible types of bus structures, such as a memory bus, memory controller, a peripheral bus, an accelerated graphics port, and a processor or local bus using any of a variety of bus architectures.

The computer 601 may operate on and/or comprise a variety of computer-readable media (e.g., non-transitory). Computer-readable media may be any available media that is accessible by the computer 601 and comprises, non-transitory, volatile and/or non-volatile media, removable and non-removable media. The system memory 612 has computer-readable media in the form of volatile memory, such as random access memory (RAM), and/or non-volatile memory, such as read-only memory (ROM). The system memory 612 may store data such as session recovery data 607 and/or program modules such as operating system 205 and session recovery software 606 that are accessible to and/or are operated on by the one or more processors 603.

The computer 601 may also comprise other removable/non-removable, volatile/non-volatile computer storage media. The mass storage device 604 may provide non-volatile storage of computer code, computer-readable instructions, data structures, program modules, and other data for the computer 601. The mass storage device 604 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 604. An operating system 605 and session recovery software 606 may be stored on the mass storage device 604. One or more of the operating system 605 and session recovery software 606 (or some combination thereof) may comprise program modules and the session recovery software 606. Session recovery data 607 may also be stored on the mass storage device 604. Session recovery data 607 may be stored in any of one or more databases known in the art. The databases may be centralized or distributed across multiple locations within the network 615.

A user may enter commands and information into the computer 601 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 603 via a human-machine interface 602 that is coupled to the bus 613, but may be connected by other interface and bus structures, such as a parallel port, game port, an IEEE 1394 Port (also known as a Firewire port), a serial port, network adapter 608, and/or a universal serial bus (USB).

A display device 611 may also be connected to the bus 613 via an interface, such as a display adapter 609. It is contemplated that the computer 601 may have more than one display adapter 609 and the computer 601 may have more than one display device 611. A display device 611 may be a monitor, an LCD (Liquid Crystal Display), a light-emitting diode (LED) display, a television, smart lens, smart glass, and/or a projector. In addition to the display device 611, other output peripheral devices may comprise components such as speakers (not shown) and a printer (not shown) which may be connected to the computer 601 via Input/Output Interface 610. Any step and/or result of the methods may be output (or caused to be output) in any form to an output device. Such output may be any form of visual representation, including, but not limited to, textual, graphical, animation, audio, tactile, and the like. The display 611 and computer 601 may be part of one device, or separate devices.

The computer 601 may operate in a networked environment using logical connections to one or more remote computing devices 614a,b,c. A remote computing device 614a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network nodes, and so on. Logical connections between the computer 601 and a remote computing device 614a,b,c may be made via a network 615, such as a local area network (LAN) and/or a general wide area network (WAN). Such network connections may be through a network adapter 608. A network adapter 608 may be implemented in both wired and wireless environments. Such networking environments are conventional and commonplace in dwellings, offices, enterprise-wide computer networks, intranets, and the Internet.

Application programs and other executable program components such as the operating system 605 are shown herein as discrete blocks, although it is recognized that such programs and components may reside at various times in different storage components of the computing device 601, and are executed by the one or more processors 603 of the computer 601. An implementation of session recovery software 606 may be stored on or sent across some form of computer-readable media. Any of the disclosed methods may be performed by processor-executable instructions embodied on computer-readable media.

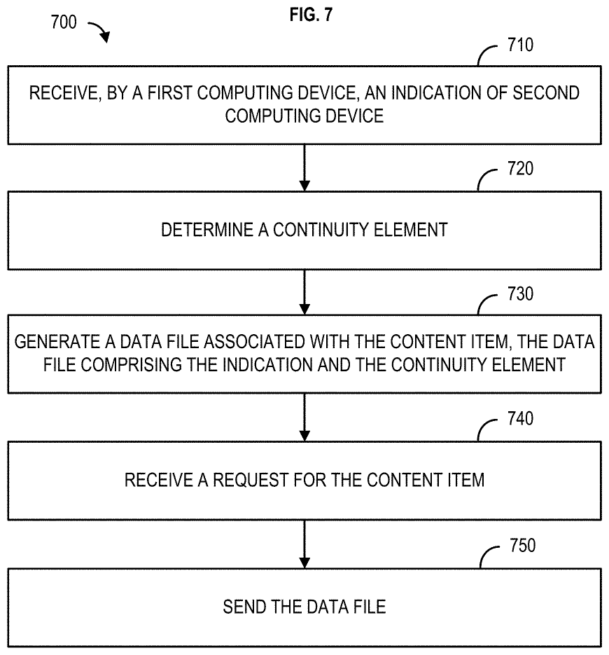

FIG. 7 shows a flowchart of an example method 700 for content delivery session recovery. At 710, an indication of a computing device may be received. A first computing device (e.g., encoder, packager, origin server, HTTP server, computing device 102, computing device 103, the computing device 310, etc.) may receive an indication of a second computing device (e.g., encoder, packager, origin server, HTTP server, computing device 102, computing device 103, the computing device 310, etc.). For example, the first computing device may receive the indication of the second computing device from a control device (e.g., a server, a computing device, a controller, the control device 105, the control 311). The indication sent to the first computing device may indicate an association or relationship between the first computing device and the second computing device. The first computing device may serve as a backup the second computing device and the second computing device may serve as a backup for the first computing device in the event one of the first computing device or the second computing device fails or is otherwise unable to process the request for MPDs from a user device (e.g., a content/media player, a client device, a smart device, a mobile device, the user device 101, user device 390, etc.) attempting a content delivery session.

At 720, a continuity element may be determined. The control device may determine a continuity element. The continuity element may be used to minimize service downtime in situations where the first computing device and the second computing device are unsynchronized. The continuity element may be determined based on continuity between a representation of a content item located at the first computing device and a representation of the content item located at the second computing device. The continuity element may include an Extensible Markup Language (XML) element within an MPD.

For example, the first computing device and the second computing device may manage/distribute the same content item (e.g., representations of the same content item, etc.), the content item managed by each computing device may have different characteristics. The content item managed/distributed by the first computing device and the second computing device may include different timestamps, different period start times, different period identifiers, and/or the like. As such, an MPD coming from the second computing device cannot be offered/used as an update for an MPD coming first computing device when there is a failure in the content delivery session initiated with the first computing device. To allow for such functionality, there is an “MPD reset” option, where the MPD signals a “fresh start” and is not a mere continuation of the previous one. In the case of redundant computing devices, such as the first computing device and the second computing device, both MPDs include the start of the first periods in the past, so in the ISO/IEC 23009-1 5^{th} ed. specification recommends canceling decoding of all upcoming samples and starting the playback of the new MPD. However, if this is done, there will be a period during which the existing segment buffer of a user device, for example, a DASH client, will be filled, and a Digital Rights Management (DRM) license would be requested. Playback would stall for this period, resulting in a poor user experience. To mitigate the downtime, caused by a reset, additional signaling, such as a continuity element and its attributes, may be included with MPDs to indicate a degree of continuity.

Determining the continuity element may include determining an asset value in an MPD. The asset value may indicate whether the representation of the content item at the first computing device is perceptually identical to the representation of the content item located at the second computing device. For example, when the asset value is set to “true,” it may indicate that the representation of the content item at the first computing device is perceptually identical to the representation of the content item at the second computing device. Accordingly, a user device may output any buffered portions of the content item received from the first computing device before a failure. For example, if the asset value is set to “true,” a user device will keep playing already downloaded content item segments from the first computing device, while downloading new content item segments from the second computing device. The user device will then switch to content item segments from the second computing device when downloaded segments from the first computing device are available/presented/displayed. If the asset value is set to “false,” it may indicate that the representation of the content item at the first computing device is not perceptually identical to the representation of the content item located at the second computing device. Accordingly, the user device may output any buffered portions of the content item. The user device may then output an indication that the content item is no longer available or output an alternative content item.

Determining the continuity element may include determining a service value in an MPD. The service value may indicate that one or more identifiers associated with the representation of the content item at the first computing device match one or more identifiers associated with the representation of the content item located at the second computing device. For example, if the service value is set to “true,” it may indicate that one or more identifiers associated with the representation of the content item at the first computing device match one or more identifiers associated with the representation of the content item located at the second computing device. Accordingly, a user device may output any buffered portions of the content item. The user device may send a request to the second computing device for at least another portion of the content item. The user device may receive and output the at least another portion of the content item. If the service value is set to “false,” it may indicate that one or more identifiers associated with the representation of the content item at the first computing device do not match one or more identifiers associated with the representation of the content item located at the second computing device. Accordingly, a user device may output any buffered portions of the content item. The user device may receive and output, based on a default service parameter, the at least another portion of the content item. The default service parameter may comprise at least one of, a default language, a default audio track, a default camera view, or a closed caption setting.

Determining the continuity element may include determining a content protection value in an MPD. If the content protection value is set to “true,” it may indicate that a security element (e.g., a DRM license, encryption key, etc.) associated with the representation of the content item at the first computing device is valid for the representation of the content item at the second computing device. The user device will continue receiving content item segments (e.g., continue the content delivery session, etc.) using the current security element (e.g., a DRM license, encryption key, etc.) instead of requesting a new security element before receiving representations of the content item from a different source/origin, which may minimize the duration of the interruption to content delivery. If the content protection value is set to “false,” it may indicate that a security element (e.g., a DRM license, encryption key, etc.) associated with the representation of the content item at the first computing device is not valid for the representation of the content item at the second computing device. Accordingly, a user device may output any buffered portions of the content item. The user device may send, to a security computing device, a request for an encryption key associated with the representation of the content item at the second computing device. The user device may receive, from the security computing device, the encryption key. The user device may send the encryption key to the second computing device. The user device may receive, based on another second request and the encryption key, at least another portion of the content item and output the at least another portion of the content item.

At 730, a data file (e.g., a media presentation description (MPD) file, a manifest file, etc.) may be generated. The first computing device may generate a data file associated with the content item. The data file may include a reference to the second computing device and the continuity element. The data file may include the reference to the second computing device so that a user device may request a fallback data file, such as a fallback MPD, from the second computing device in the event that the first computing device fails.

At 740, a request for a content item (e.g., streaming video/audio, video-on-demand (VOD), multimedia, etc.) may be received. The first computing device may receive a request for a content item from a user device.

At 750, the data file may be sent. The first user device may send the data file to the user device. The user device may use the data file to request a portion/segment of the content item. The user device may request an update to the data file, at regular intervals, to retrieve a next portion/segment of the content item. In the event of a failure between the user device and the first computing device, the user device may use the URL of the second computing device included with the last MPD update received from the first computing device to request a fallback MPD from the second computing device. The continuity element may instruct the user device how to perform, in the event of a failure, to minimize service downtime in the case where the first computing device and the second computing device are unsynchronized.

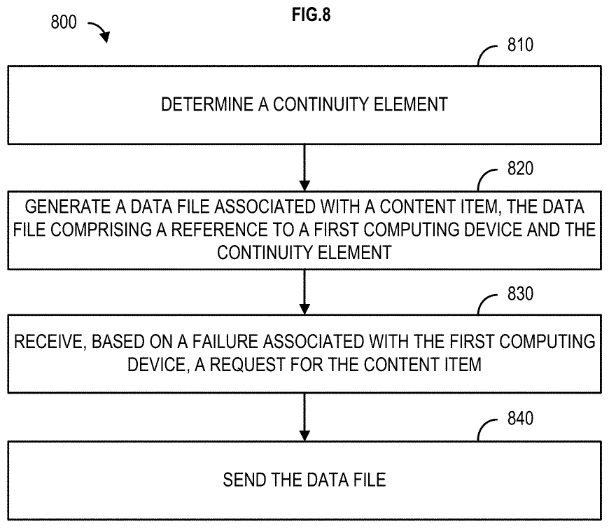

FIG. 8 shows a flowchart of an example method 800 for content delivery session recovery. At 810, a continuity element may be determined. A control device (e.g., a server, a computing device, a controller, the control device 105, the control 311) may determine a continuity element. The continuity element may be used to minimize service downtime in situations where a first computing device (e.g., encoder, packager, origin server, HTTP server, computing device 102, computing device 103, the computing device 310, etc.) and a second computing device (e.g., encoder, packager, origin server, HTTP server, computing device 102, computing device 103, the computing device 310, etc.) are unsynchronized. The continuity element may be determined based on continuity between a representation of a content item located at the first computing device and a representation of the content item located at the second computing device. The continuity element may include an Extensible Markup Language (XML) element within an MPD.

The first computing device and/or the second computing device may receive an indication of the other computing device from the control device. The indication sent to the first computing device and/or the second computing may indicate an association or relationship between first computing device and the second computing device. The first computing device may serve as a backup the second computing device and the second computing device may serve as a backup for the first computing device in the event one of the first computing device or the second computing device fails or is otherwise unable to process request for MPDs from a user device (e.g., a content/media player, a client device, a smart device, a mobile device, the user device 101, user device 390, etc.) attempting a content delivery session.

For example, the first computing device and the second computing device may manage/distribute the same content item (e.g., representations of the same content item, etc.), the content item managed by each computing device may have different characteristics. The content item managed/distributed by the first computing device and the second computing device may include different timestamps, different period start times, different period identifiers, and/or the like. As such, an MPD coming from the second computing device cannot be offered/used as an update for an MPD coming first computing device when there is a failure in the content delivery session initiated with the first computing device. To allow for such functionality, there is an “MPD reset” option, where the MPD signals a “fresh start” and is not a mere continuation of the previous one. In the case of redundant computing devices, such as the first computing device and the second computing device, both MPDs include the start of the first periods in the past, so in the ISO/IEC 23009-1 5^{th} ed. specification recommends canceling decoding of all upcoming samples and starting the playback of the new MPD. However, if this is done, there will be a period during which the existing segment buffer of a user device, for example, a DASH client, will be filled, and a Digital Rights Management (DRM) license would be requested. Playback would stall for this period, resulting in a poor user experience. To mitigate the downtime, caused by a reset, additional signaling, such as a continuity element and its attributes, may be included with MPDs to indicate a degree of continuity.

Determining the continuity element may include determining an asset value in an MPD. The asset value may indicate whether the representation of the content item at the first computing device is perceptually identical to the representation of the content item located at the second computing device. For example, when the asset value is set to “true,” it may indicate that the representation of the content item at the first computing device is perceptually identical to the representation of the content item at the second computing device. Accordingly, a user device may output any buffered portions of the content item received from the first computing device prior to a failure. For example, if the asset value is set to “true,” a user device will keep playing already downloaded content item segments from the first computing device while downloading new content item segments from the second computing device. The user device will then switch to content item segments from the second computing device when downloaded segments from the first computing device are available/presented/displayed. If the asset value is set to “false,” it may indicate that the representation of the content item at the first computing device is not perceptually identical to the representation of the content item located at the second computing device. Accordingly, the user device may output any buffered portions of the content item. The user device may then output an indication that the content item is no longer available or output an alternative content item.

Determining the continuity element may include determining a service value in an MPD. The service value may indicate that one or more identifiers associated with the representation of the content item at the first computing device match one or more identifiers associated with the representation of the content item located at the second computing device. For example, if the service value is set to “true,” it may indicate that one or more identifiers associated with the representation of the content item at the first computing device match one or more identifiers associated with the representation of the content item located at the second computing device. Accordingly, a user device may output any buffered portions of the content item. The user device may send a request to the second computing device for at least another portion of the content item. The user device may receive and output the at least another portion of the content item. If the service value is set to “false,” it may indicate that one or more identifiers associated with the representation of the content item at the first computing device do not match one or more identifiers associated with the representation of the content item located at the second computing device. Accordingly, a user device may output any buffered portions of the content item. The user device may receive and output, based on a default service parameter, the at least another portion of the content item. The default service parameter may comprise at least one of, a default language, a default audio track, a default camera view, or a closed caption setting.

Determining the continuity element may include determining a content protection value in an MPD. If the content protection value is set to “true,” it may indicate that a security element (e.g., a DRM license, encryption key, etc.) associated with the representation of the content item at the first computing device is valid for the representation of the content item at the second computing device. The user device will continue receiving content item segments (e.g., continue the content delivery session, etc.) using the current security element (e.g., a DRM license, encryption key, etc.) instead of requesting a new security element before receiving representations of the content item from a different source/origin, which may minimize the duration of the interruption to content delivery. If the content protection value is set to “false,” it may indicate that a security element (e.g., a DRM license, encryption key, etc.) associated with the representation of the content item at the first computing device is not valid for the representation of the content item at the second computing device. Accordingly, a user device may output any buffered portions of the content item. The user device may send, to a security computing device, a request for an encryption key associated with the representation of the content item at the second computing device. The user device may receive, from the security computing device, the encryption key. The user device may send the encryption key to the second computing device. The user device may receive, based on another second request and the encryption key, at least another portion of the content item and output the at least another portion of the content item.

At 820, a data file (e.g., a media presentation description (MPD) file, a manifest file, etc.) may be generated. The second computing device may generate a data file associated with the content item. The data file may include a reference to the first computing device and the continuity element. For example, the second computing device may generate and store data files that reference a representation of a content item that is also at/provided by the first computing device. The second computing device may generate the data file so that in the event of a failure associated with the first computing device the user device may retrieve a fallback data file from the second user device. The second computing device may generate and/or store fallback MPDs based on the indication from the control device of the relationship (redundancy relationship) between the second computing device and the first computing device.

At 830, a request for the content item (e.g., streaming video/audio, video-on-demand (VOD), multimedia, etc.) may be received. The second computing device may receive a request for the content item from a user device. For example, the user device receiving data files from the first computing device may request content from the second computing device because of a failure associated with the first computing device. Data files received by the user device from the first computing device to access the content item before the failure of the first computing device may include a reference to the second computing device and the continuity element. The data file may include the reference to the second computing device so that a user device may request a fallback data file, such as a fallback MPD, from the second computing device based on the failure associated with the first computing device. The second computing device may generate the fallback data file based on the request for the content item from the user device. The continuity element may instruct the user device how to perform, based on the failure, to minimize service downtime in the case where the first computing device and the second computing device are unsynchronized. For example, the attributes of the continuity element may dictate if the user device empties or retains portions/segments of the content item within its buffers, requests a security element, and/or the like

At 840, the data file may be sent. The second user device may send the data file to the user device. The user device may use the data file to request a portion/segment of the content item. The user device may request an update to the data file, at regular intervals, to retrieve a next portion/segment of the content item.

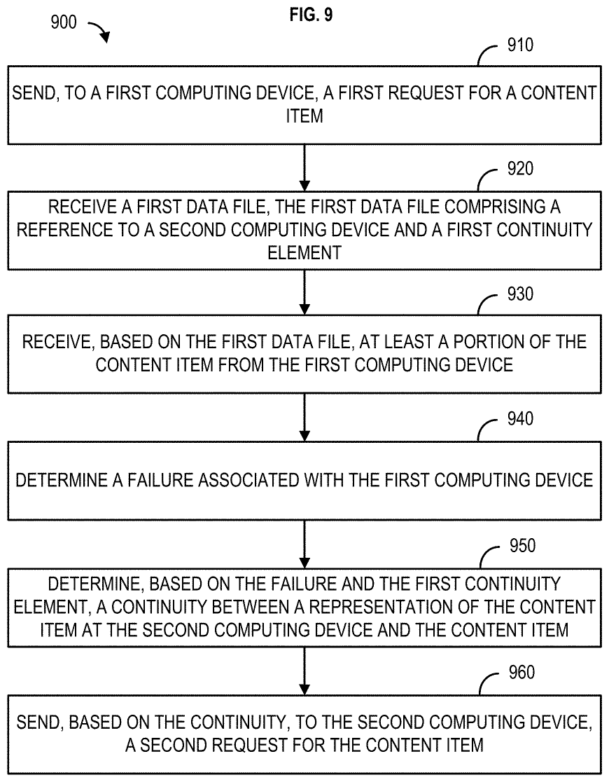

FIG. 9 shows a flowchart of an example method 900 for content delivery session recovery. At 910, a first request for a content item (e.g., streaming video/audio, video on demand (VOD), multimedia, etc.) may be sent. A user device (e.g., a content/media player, a client device, a smart device, a mobile device, the user device 101, user device 390, etc.) may send a request for a content item to a first computing device (e.g., encoder, packager, origin server, HTTP server, computing device 102, computing device 103, the computing device 310, etc.).

At 920, a first data file (e.g., a media presentation description (MPD) file, a manifest file, etc.) may be received. The user device may receive the first data file from the first computing device based on the first request. The first data file may include one or more references, such as URLs, to portions/segments of the content item. The first data file may include a reference to a second computing device (e.g., encoder, packager, origin server, HTTP server, computing device 102, computing device 103, the computing device 310, etc.) and a first continuity element.

The first computing device and the second computing device may share a relationship. The first computing device and/or the second computing device may receive an indication of the relationship from a control device (e.g., a server, a computing device, a controller, the control device 105, the control 311). The indication sent to the first computing device and/or the second computing may indicate an association or relationship between the first computing device and the second computing device. The first computing device may serve as a backup the second computing device and the second computing device may serve as a backup for the first computing device in the event one of the first computing device or the second computing device fails or is otherwise unable to process the request for MPDs from the user device when attempting a content delivery session.

For example, the first computing device and the second computing device may manage/distribute the same content item (e.g., representations of the same content item, etc.), the content item managed by each computing device may have different characteristics. The content item managed/distributed by the first computing device and the second computing device may include different timestamps, different period start times, different period identifiers, and/or the like. As such, an MPD coming from the second computing device cannot be offered/used as an update for an MPD coming first computing device when there is a failure in the content delivery session initiated with the first computing device. To allow for such functionality, there is an “MPD reset” option, where the MPD signals a “fresh start” and is not a mere continuation of the previous one. In the case of redundant computing devices, such as the first computing device and the second computing device, both MPDs include the start of the first periods in the past, so in the ISO/IEC 23009-1 5^{th} ed. specification recommends canceling decoding of all upcoming samples and starting the playback of the new MPD. However, if this is done, there will be a period during which the existing segment buffer of a user device, for example, a DASH client, will be filled, and a Digital Rights Management (DRM) license would be requested. Playback would stall for this period, resulting in a poor user experience. To mitigate the downtime, caused by a reset, additional signaling, such as a continuity element and its attributes, may be included with MPDs to indicate a degree of continuity.

A continuity element may be determined based on continuity between a representation of a content item located at the first computing device and a representation of the content item located at the second computing device. The continuity element may include an Extensible Markup Language (XML) element within an MPD. A continuity element may instruct the user device how to perform, based on a failure to a content delivery session, to minimize service downtime. As such, the first computing device, when generating the first data file, may include the first content element to instruct the user device how to perform in the event of a failure and/or when the first computing device and the second computing device are unsynchronized. For example, the attributes of the continuity element may dictate if the user device empties or retains portions/segments of a content item within its buffers, requests a security element (e.g., DRM license, etc.), and/or the like.

At 930, at least a portion of the content item may be received. The user device may receive, based on the first data file, at least a portion of the content item from the first computing device. For example, the first data file may include references (e.g., URLs, etc.) to portions of the content. The user device may use the references to request at least a portion of the content item from the first computing device.

At 940, a failure may be determined. The user device may determine a failure associated with the first computing device. The user device may determine the failure based on not receiving additional portions of the content item from the first computing device and/or a next data file, for example, within a time window. The failure to receive the additional portions of the content item and/or the next data file may be due to the first computing device shutting down, becoming overloaded, being damaged, encountering network issues, and/or the like. The user device and/or a computing device may determine the failure. In an embodiment, an MPD reset descriptor (e.g., a descriptor defined in section 5.4.2 of the MPEG DASH specification), may be used to signal the failure. In an embodiment, the failure may be signalled within a fallback MPD chaining descriptor (as defined in section 5.11.2 of the MPEG DASH specification). For example, the user device may request the next data file in the sequence from the first user device, the request will fail, and the user device will request a fallback MPD from the second user device. The same continuity properties as in MPD reset apply in this situation—a difference being that the user device and not the first computing device discovers the failure.

Typically, in the event of a failure, an MPD reset option with a data file is used, wherein the MPD signals a “fresh start” rather than the continuation of the previous MPD. In the case of redundant origins, such as the first computing device and the second computing device, data files (e.g., MPDs) generated by the redundant origins will have the start of the first periods in the past, so in this case, the MPEG DASH specification recommends canceling decoding of all upcoming samples and starting the playback of the new MPD. If this is done, there will be a period during which the existing segment buffer of the DASH client will be filled, and the DRM license would be requested. Playback would stall for this period, resulting in a bad user experience. The first continuity element may mitigate downtime by indicating a continuity between a representation of the content item located at the first computing device and a representation of the content item located at the second computing device.

At 950, a continuity between a representation of the content item at the second computing device and the content item may be determined. The continuity may be determined in response to the failure. For example, based on the failure, the user device may access the first continuity element in the first data file to determine how to perform in response to the failure. For example, the attributes of the first continuity element may dictate if the user device empties or retains portions/segments of the content item within its buffers, requests a security element (e.g., DRM license, etc.), and/or the like.

For example, determining a continuity between a representation of the content item at the second computing device and the content item may be based on an asset value of the first continuity element. The asset value may indicate whether the representation of the content item at the first computing device is perceptually identical to the representation of the content item located at the second computing device. For example, when the asset value is set to “true,” it may indicate that the representation of the content item at the first computing device is perceptually identical to the representation of the content item at the second computing device. Accordingly, a user device may output any buffered portions of the content item received from the first computing device before a failure. For example, if the asset value is set to “true,” a user device will keep playing already downloaded content item segments from the first computing device while downloading new content item segments from the second computing device. The user device will then switch to content item segments from the second computing device when downloaded segments from the first computing device are available/presented/displayed. If the asset value is set to “false,” it may indicate that the representation of the content item at the first computing device is not perceptually identical to the representation of the content item located at the second computing device. Accordingly, the user device may output any buffered portions of the content item. The user device may then output an indication that the content item is no longer available or output an alternative content item.

Determining the continuity element may include determining a service value in an MPD. The service value may indicate that one or more identifiers associated with the representation of the content item at the first computing device match one or more identifiers associated with the representation of the content item located at the second computing device. For example, if the service value is set to “true,” it may indicate that one or more identifiers associated with the representation of the content item at the first computing device match one or more identifiers associated with the representation of the content item located at the second computing device. Accordingly, a user device may output any buffered portions of the content item. The user device may send a request to the second computing device for at least another portion of the content item. The user device may receive and output the at least another portion of the content item. If the service value is set to “false,” it may indicate that one or more identifiers associated with the representation of the content item at the first computing device do not match one or more identifiers associated with the representation of the content item located at the second computing device. Accordingly, a user device may output any buffered portions of the content item. The user device may receive and output, based on a default service parameter, the at least another portion of the content item. The default service parameter may comprise at least one of, a default language, a default audio track, a default camera view, or a closed caption setting.

Determining the continuity element may include determining a content protection value in an MPD. If the content protection value is set to “true,” it may indicate that a security element (e.g., a DRM license, encryption key, etc.) associated with the representation of the content item at the first computing device is valid for the representation of the content item at the second computing device. The user device will continue receiving content item segments (e.g., continue the content delivery session, etc.) using the current security element (e.g., a DRM license, encryption key, etc.) instead of requesting a new security element before receiving representations of the content item from a different source/origin, which may minimize the duration of the interruption to content delivery. If the content protection value is set to “false,” it may indicate that a security element (e.g., a DRM license, encryption key, etc.) associated with the representation of the content item at the first computing device is not valid for the representation of the content item at the second computing device. Accordingly, a user device may output any buffered portions of the content item. The user device may send, to a security computing device, a request for an encryption key associated with the representation of the content item at the second computing device. The user device may receive, from the security computing device, the encryption key. The user device may send the encryption key to the second computing device. The user device may receive, based on another second request and the encryption key, at least another portion of the content item and output the at least another portion of the content item.

At 960, a second request for the content item may be sent. The user may send a second request for the content item. The user device may determine, based on a reference to the second computing device included with the first data file, that the second user device is a backup for the first user device and that a fallback data file may be requested from the second computing device. The fallback data file may be used to request the next portion of the content item. The user device may request the next portion of the content item based on attribute settings of the first continuity element. As described, the first continuity element may instruct the user device how to perform, based on the failure, to minimize service downtime. For example, the attributes of the first continuity element may dictate if the user device empties or retains portions/segments of the content item within its buffers, requests a security element (e.g., request a new DRM license, etc.), and/or the like.

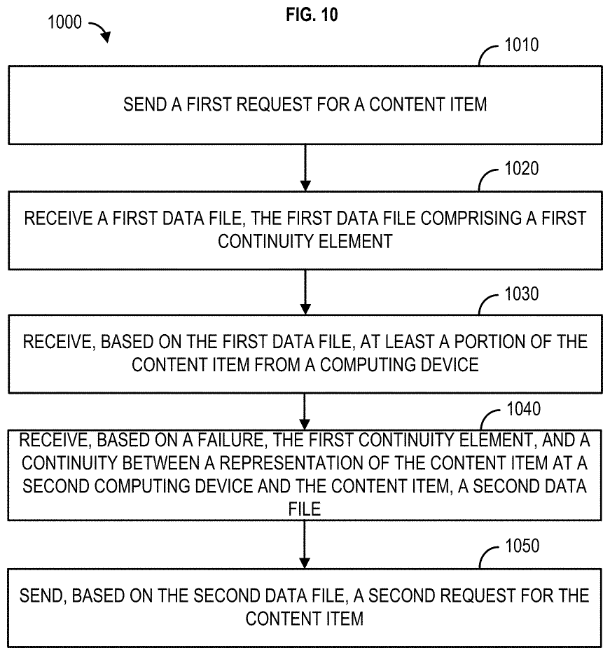

FIG. 10 shows a flowchart of an example method 900 for content delivery session recovery. At 1010, a first request for a content item (e.g., streaming video/audio, video on demand (VOD), multimedia, etc.) may be sent. A user device (e.g., a content/media player, a client device, a smart device, a mobile device, the user device 101, user device 390, etc.) may send a request for a content item to a computing device (e.g., a just-in-time (JIT) packager, a server, an intermediate device 106, etc.). The computing device may serve as an intermediate for content delivery to the user device. To reduce bandwidth and network storage requirements, the intermediate device may prepare a content item (e.g., streaming video/audio, video-on-demand (VOD), multimedia, etc.) for delivery to the user device at the point when the user device requests the content item. The intermediate device may request the content item, on behalf of the user device, from a first computing device (e.g., a computing device, an encoder, a packager, an origin server, an HTTP server, the computing device 310, etc.), the intermediate device may generate the appropriate packages (data files), automatically, and select an appropriate media packaging and licensing formats (e.g., DRM formats, etc.).

At 1020, a first data file (e.g., a media presentation description (MPD) file, a manifest file, etc.) may be received. The user device may receive the first data file from the computing device based on the first request. The first data file may be derived from a data file sent to the computing device from the first computing device. The first data file may include one or more references, such as URLs, to portions/segments of the content item and a first continuity element.

The first computing device and a second computing device (e.g., encoder, packager, origin server, HTTP server, computing device 102, computing device 103, the computing device 310, etc.) may share a relationship. The first computing device and/or the second computing device may receive an indication of the relationship from a control device (e.g., a server, a computing device, a controller, the control device 105, the control 311). The indication sent to the first computing device and/or the second computing may indicate an association or relationship between the first computing device and the second computing device. The first computing device may serve as a backup the second computing device and the second computing device may serve as a backup for the first computing device in the event one of the first computing device or the second computing device fails or is otherwise unable to process the request for MPDs from the user device when attempting a content delivery session.

For example, the first computing device and the second computing device may manage/distribute the same content item (e.g., representations of the same content item, etc.), the content item managed by each computing device may have different characteristics. The content item managed/distributed by the first computing device and the second computing device may include different timestamps, different period start times, different period identifiers, and/or the like. As such, an MPD coming from the second computing device cannot be offered/used as an update for an MPD coming first computing device when there is a failure in the content delivery session initiated with the first computing device. To allow for such functionality, there is an “MPD reset” option, where the MPD signals a “fresh start” and is not a mere continuation of the previous one. In the case of redundant computing devices, such as the first computing device and the second computing device, both MPDs include the start of the first periods in the past, so the ISO/IEC 23009-1 5^{th} ed. specification recommends canceling decoding of all upcoming samples and starting the playback of the new MPD. However, if this is done, there will be a period during which the existing segment buffer of a user device, for example, a DASH client, will be filled, and a Digital Rights Management (DRM) license would be requested. Playback would stall for this period, resulting in a poor user experience. To mitigate the downtime, caused by a reset, additional signaling, such as a continuity element and its attributes, may be included with MPDs to indicate a degree of continuity.

A continuity element may be determined based on a continuity between a representation of a content item located at the first computing device and a representation of the content item located at the second computing device. The continuity element may include an Extensible Markup Language (XML) element within an MPD. A continuity element may instruct the user device how to perform, based on a failure to a content delivery session, to minimize service downtime. As such, the first computing device, when generating the data file, may include the first content element to instruct the user device how to perform in the event of a failure and/or when the first computing device and the second computing device are unsynchronized. The computing device may derive the first data file from the first computing device and include the first continuity element. The attributes of the first continuity element may dictate if the user device empties or retains portions/segments of a content item within its buffers, requests a security element (e.g., DRM license, etc.), and/or the like.

At 1030, at least a portion of the content item may be received. The user device may receive, based on the first data file, at least a portion of the content item from the first computing device. For example, the first data file may include references (e.g., URLs, etc.) to portions of the content. The user device may use the references to request at least a portion of the content item from the first computing device.

At 1040, a second data file may be received. The user device may receive the second data file from the computing device. The user device may receive the second data file from the computing device based on a failure. The computing device may determine a failure associated with the first computing device. The computing device may determine the failure based on not receiving a next data file, for example, within a time window. The failure to receive the next data file may be due to the first computing device shutting down, becoming overloaded, being damaged, encountering network issues, and/or the like.

In an embodiment, an MPD reset descriptor (e.g., a descriptor defined in section 5.4.2 of the MPEG DASH specification), may be used to signal the failure. In an embodiment, the failure may be signalled within a fallback MPD chaining descriptor (as defined in section 5.11.2 of the MPEG DASH specification). Typically, in the event of a failure, an MPD reset option with a data file is used, wherein the MPD signals a “fresh start” rather than continuation of the previous MPD. In the case of redundant origins, such as the first computing device and the second computing device, data files (e.g., MPDs) generated by the redundant origins will have the start of the first periods in the past, so in this case, the MPEG DASH specification recommends canceling decoding of all upcoming samples and starting the playback of the new MPD. If this is done, there will be a period during which the existing segment buffer of the DASH client will be filled, and the DRM license would be requested. Playback would stall for this period, resulting in a bad user experience. The first continuity element may mitigate downtime by indicating a continuity between a representation of the content item located at the first computing device and a representation of the content item located at the second computing device.

A continuity between a representation of the content item at the second computing device and the content item may be determined. The continuity may be determined in response to the failure. For example, in based on the failure, the computing device may access the first continuity element in the first data file and copy the setting of the first continuity element into a second data file that is sent to the user device. As such, the user device may be unaware of the failure because the computing device retrieved a fallback data file and used it to generate the second data file. The continuity element in the second data file may instruct the user device. For example, based on the continuity element in the second data file, the user device may empty or retain portions/segments of the content item within its buffers, request a security element (e.g., DRM license, etc.), or continue using a current security element, and/or the like.

For example, determining a continuity between a representation of the content item at the second computing device and the content item may be based on an asset value of the first continuity element. The asset value may indicate whether the representation of the content item at the first computing device is perceptually identical to the representation of the content item located at the second computing device. For example, when the asset value is set to “true,” it may indicate that the representation of the content item at the first computing device is perceptually identical to the representation of the content item at the second computing device. Accordingly, a user device may output any buffered portions of the content item received from the first computing device before a failure. For example, if the asset value is set to “true,” a user device will keep playing already downloaded content item segments from the first computing device while downloading new content item segments from the second computing device. The user device will then switch to content item segments from the second computing device when downloaded segments from the first computing device are available/presented/displayed. If the asset value is set to “false,” it may indicate that the representation of the content item at the first computing device is not perceptually identical to the representation of the content item located at the second computing device. Accordingly, the user device may output any buffered portions of the content item. The user device may then output an indication that the content item is no longer available or output an alternative content item.

Determining the continuity element may include determining a service value in an MPD. The service value may indicate that one or more identifiers associated with the representation of the content item at the first computing device match one or more identifiers associated with the representation of the content item located at the second computing device. For example, if the service value is set to “true,” it may indicate that one or more identifiers associated with the representation of the content item at the first computing device match one or more identifiers associated with the representation of the content item located at the second computing device. Accordingly, a user device may output any buffered portions of the content item. The user device may send a request to the second computing device for at least another portion of the content item. The user device may receive and output the at least another portion of the content item. If the service value is set to “false,” it may indicate that one or more identifiers associated with the representation of the content item at the first computing device do not match one or more identifiers associated with the representation of the content item located at the second computing device. Accordingly, a user device may output any buffered portions of the content item. The user device may receive and output, based on a default service parameter, the at least another portion of the content item. The default service parameter may comprise at least one of, a default language, a default audio track, a default camera view, or a closed caption setting.

Determining the continuity element may include determining a content protection value in an MPD. If the content protection value is set to “true,” it may indicate that a security element (e.g., a DRM license, encryption key, etc.) associated with the representation of the content item at the first computing device is valid for the representation of the content item at the second computing device. The user device will continue receiving content item segments (e.g., continue the content delivery session, etc.) using the current security element (e.g., a DRM license, encryption key, etc.) instead of requesting a new security element before receiving representations of the content item from a different source/origin, which may minimize the duration of the interruption to content delivery. If the content protection value is set to “false,” it may indicate that a security element (e.g., a DRM license, encryption key, etc.) associated with the representation of the content item at the first computing device is not valid for the representation of the content item at the second computing device. Accordingly, a user device may output any buffered portions of the content item. The user device may send, to a security computing device, a request for an encryption key associated with the representation of the content item at the second computing device. The user device may receive, from the security computing device, the encryption key. The user device may send the encryption key to the second computing device. The user device may receive, based on another second request and the encryption key, at least another portion of the content item and output the at least another portion of the content item.

At 1050, a second request for the content item may be sent. The user may send a second request for the content item. The user device may use references (e.g., URLs, etc.) included in the second data file to request a net portion of the content item.

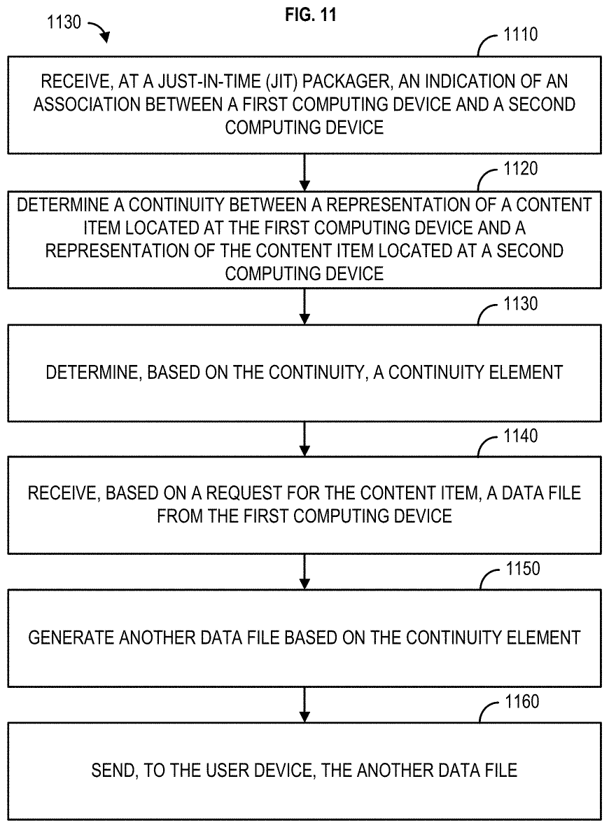

FIG. 11 shows a flowchart of an example method 1100 for content delivery session recovery. At 1110, an indication of an association between a first computing device (e.g., encoder, packager, origin server, HTTP server, computing device 102, computing device 103, the computing device 310, etc.) and a second computing device (e.g., encoder, packager, origin server, HTTP server, computing device 102, computing device 103, the computing device 310, etc.) may be received. A just-in-time packager (JIT) may receive an indication of an association between the first computing device and the second computing device. For example, the JIT may receive the indication of the associate from a control device (e.g., a server, a computing device, a controller, the control device 105, the control 311). The first computing device may serve as a backup the second computing device and the second computing device may serve as a backup for the first computing device in the event one of the first computing device or the second computing device fails or is otherwise unable to process a request for MPDs from a user device (e.g., a content/media player, a client device, a smart device, a mobile device, the user device 101, user device 390, etc.) attempting a content delivery session.

At 1120, a continuity may be determined. The JIT may determine a continuity between a representation of a content item located at the first computing device and a representation of the content item located at a second computing device. Determining the continuity may be based on the indication from the control device.

At 1120, a continuity element may be determined. The JIT may determine a continuity element. The continuity element may be used to minimize service downtime in situations where the first computing device and the second computing device are unsynchronized. The continuity element may be determined based on the continuity between a representation of a content item located at the first computing device and a representation of the content item located at the second computing device. The continuity element may include an Extensible Markup Language (XML) element within an MPD.

For example, the first computing device and the second computing device may manage/distribute the same content item (e.g., representations of the same content item, etc.), the content item managed by each computing device may have different characteristics. The content item managed/distributed by the first computing device and the second computing device may include different timestamps, different period start times, different period identifiers, and/or the like. As such, an MPD coming from the second computing device cannot be offered/used as an update for an MPD coming first computing device when there is a failure in the content delivery session initiated with the first computing device. To allow for such functionality, there is an “MPD reset” option, where the MPD signals a “fresh start” and is not a mere continuation of the previous one. In the case of redundant computing devices, such as the first computing device and the second computing device, both MPDs include the start of the first periods in the past, so the ISO/IEC 23009-1 5^{th} ed. specification recommends canceling decoding of all upcoming samples and starting the playback of the new MPD. However, if this is done, there will be a period during which the existing segment buffer of a user device, for example, a DASH client, will be filled, and a Digital Rights Management (DRM) license would be requested. Playback would stall for this period, resulting in a poor user experience. To mitigate the downtime, caused by a reset, additional signalings, such as a continuity element and its attributes, may be included with MPDs to indicate a degree of continuity.

Determining the continuity element may include determining an asset value in an MPD. The asset value may indicate whether the representation of the content item at the first computing device is perceptually identical to the representation of the content item located at the second computing device. For example, when the asset value is set to “true,” it may indicate that the representation of the content item at the first computing device is perceptually identical to the representation of the content item at the second computing device. Accordingly, a user device may output any buffered portions of the content item received from the first computing device before a failure. For example, if the asset value is set to “true,” a user device will keep playing already downloaded content item segments from the first computing device while downloading new content item segments from the second computing device. The user device will then switch to content item segments from the second computing device when downloaded segments from the first computing device are available/presented/displayed. If the asset value is set to “false,” it may indicate that the representation of the content item at the first computing device is not perceptually identical to the representation of the content item located at the second computing device. Accordingly, the user device may output any buffered portions of the content item. The user device may then output an indication that the content item is no longer available or output an alternative content item.

Determining the continuity element may include determining a service value in an MPD. The service value may indicate that one or more identifiers associated with the representation of the content item at the first computing device match one or more identifiers associated with the representation of the content item located at the second computing device. For example, if the service value is set to “true,” it may indicate that one or more identifiers associated with the representation of the content item at the first computing device match one or more identifiers associated with the representation of the content item located at the second computing device. Accordingly, a user device may output any buffered portions of the content item. The user device may send a request to the second computing device for at least another portion of the content item. The user device may receive and output the at least another portion of the content item. If the service value is set to “false,” it may indicate that one or more identifiers associated with the representation of the content item at the first computing device do not match one or more identifiers associated with the representation of the content item located at the second computing device. Accordingly, a user device may output any buffered portions of the content item. The user device may receive and output, based on a default service parameter, the at least another portion of the content item. The default service parameter may comprise at least one of, a default language, a default audio track, a default camera view, or a closed caption setting.

Determining the continuity element may include determining a content protection value in an MPD. If the content protection value is set to “true,” it may indicate that a security element (e.g., a DRM license, encryption key, etc.) associated with the representation of the content item at the first computing device is valid for the representation of the content item at the second computing device. The user device will continue receiving content item segments (e.g., continue the content delivery session, etc.) using the current security element (e.g., a DRM license, encryption key, etc.) instead of requesting a new security element before receiving representations of the content item from a different source/origin, which may minimize the duration of the interruption to content delivery. If the content protection value is set to “false,” it may indicate that a security element (e.g., a DRM license, encryption key, etc.) associated with the representation of the content item at the first computing device is not valid for the representation of the content item at the second computing device. Accordingly, a user device may output any buffered portions of the content item. The user device may send, to a security computing device, a request for an encryption key associated with the representation of the content item at the second computing device. The user device may receive, from the security computing device, the encryption key. The user device may send the encryption key to the second computing device. The user device may receive, based on another second request and the encryption key, at least another portion of the content item and output the at least another portion of the content item.

At 1130, a data file (e.g., a media presentation description (MPD) file, a manifest file, etc.) may be received. The JIT may receive the first data file from the first computing device. The first computing device may generate data files associated with the content item. The data file may include a reference to the second computing device and the continuity element. The data file may include the reference to the second computing device so that the JIT may request a fallback data file, such as a fallback MPD, from the second computing device if the first computing device fails.

At 1140, another data file may be generated. The JIT may generate another data file based on the data file. The JIT may generate another data file that includes the continuity element setting from the data file.

At 1150, the another data file may be sent. The JIT may send the another data file to the user device. The user device may use the data file from the JIT to request a portion/segment of the content item. The user device may request an update to the data file, at regular intervals, to retrieve a next portion/segment of the content item. In the event of a failure between the JIT and the first computing device, the user device may be unaware.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a first computing device, an indication of a second computing device;
determining, based on a continuity between a representation of a content item located at the first computing device and a representation of the content item located at the second computing device, a continuity element;
generating, by the first computing device, a data file associated with the content item, wherein the data file comprises a reference to the second computing device and the continuity element;
receiving, by the first computing device from a user device, a request for the content item; and
sending, by the first computing device to the user device, the data file.

2. The method of claim 1, wherein determining, based on the continuity between the representation of the content item located at the first computing device and the representation of the content item located at the second computing device, the continuity element comprises:
determining a content protection value, wherein the content protection value indicates whether a license associated with the representation of the content item at the first computing device is valid for the representation of the content item at the second computing device.

3. The method of claim 1, wherein determining, based on the continuity between the representation of the content item located at the first computing device and the representation of the content item located at the second computing device, the continuity element comprises:
determining a service value, wherein the service value indicates that at least one identifier associated with the representation of the content item at the first computing device matches at least one identifier associated with the representation of the content item located at the second computing device.

4. The method of claim 1, wherein the continuity element comprises an Extensible Markup Language (XML) element.

5. The method of claim 1, wherein the data file comprises a media presentation description (MPD) file.

6. The method of claim 1, wherein the data file comprises at least one reference to a portion of the representation of the content item located at the first computing device.

7. The method of claim 1, further comprising determining that the first computing device is associated with the second computing device.

8. The method of claim 7, wherein determining that the first computing device is associated with the second computing device comprises determining that the first computing device and the second computing device each comprise the representation of the content item.

9. A method comprising:
determining, based on a continuity between a representation of a content item located at a first computing device and a representation of the content item located at a second computing device, a continuity element;
generating, by the second computing device, a data file associated with the content item, wherein the data file comprises a reference to the first computing device and the continuity element;
receiving, by the second computing device from a user device, based on a failure associated with the first computing device, a request for the content item; and
sending, by the second computing device to the user device, the data file.

10. The method of claim 9, wherein determining, based on the continuity between the representation of the content item located at the first computing device and the representation of the content item located at the second computing device, the continuity element comprises:
determining an asset value, wherein the asset value indicates whether the representation of the content item at the first computing device is perceptually identical to the representation of the content item located at the second computing device.

11. The method of claim 9, wherein determining, based on the continuity between the representation of the content item located at the first computing device and the representation of the content item located at the second computing device, the continuity element comprises:
determining a service value, wherein the service value indicates that at least one identifier associated with the representation of the content item at the first computing device matches at least one identifier associated with the representation of the content item located at the second computing device.

12. The method of claim 9, wherein determining, based on the continuity between the representation of the content item located at the first computing device and the representation of the content item located at the second computing device, the continuity element comprises:
determining a content protection value, wherein the content protection value indicates whether a license associated with the representation of the content item at the first computing device is valid for the representation of the content item at the second computing device.

13. The method of claim 11, wherein the data file comprises a media presentation description (MPD) file.

14. The method of claim 11, wherein the data file comprises at least one reference to a portion of the representation of the content item located at the second computing device.

15. The method of claim 11, further comprising determining, by a control device, that the first computing device is associated with the second computing device.

16. The method of claim 18, wherein determining, by the control device, that the first computing device is associated with the second computing device comprises determining that the first computing device and the second computing device each comprise the representation of the content item.

17. A method comprising:
sending, by a user device to a first computing device, a first request for a content item;
receiving, from the first computing device, based on the first request, a first data file, wherein the first data file comprises a reference to a second computing device and a first continuity element;
receiving, based on the first data file, at least a portion of the content item from the first computing device;
determining a failure associated with the first computing device;
determining, based on the failure associated with the first computing device and the first continuity element, a continuity between a representation of the content item at the second computing device and the content item; and
sending, based on the continuity to the second computing device, to the second computing device, a second request for the content item.

18. The method of claim 17, wherein determining the failure associated with the first computing device comprises receiving no additional portions of the content item from the first computing device.

19. The method of claim 17, wherein determining, based on the failure associated with the first computing device and the first continuity element, the continuity between the representation of the content item at the second computing device and the content item comprises:
determining an asset value, wherein the asset value indicates whether the representation of the content item at the first computing device is perceptually identical to the representation of the content item located at the second computing device; and
outputting any buffered portions of the content item.

20. The method of claim 17, further comprising receiving, from the second computing device, based on the second request, a second data file, wherein the second data file comprises a reference to the first computing device and a second continuity element.
